(19) United States
(12) Patent Application Publication
(10) Pub. No.: US 2013/0051104 A1
(43) Pub. Date: Feb. 28, 2013

(54) Battery Adapter and Power Source Device Employing Same

(71) Applicants: Yasushi Nakano, Hitachinaka (JP); Yukihiro Shima, Hitachinaka (JP); Kazuhiko Funabashi, Hitachinaka (JP); Nobuhiro Takano, Hitachinaka (JP); Yoshikazu Kawano, Hitachinaka (JP); Masayuki Ogura, Hitachinaka (JP); Shinji Watanabe, Hitachinaka (JP); Haruhisa Fujisawa, Hitachinaka (JP)

(72) Inventors: Yasushi Nakano, Hitachinaka (JP); Yukihiro Shima, Hitachinaka (JP); Kazuhiko Funabashi, Hitachinaka (JP); Nobuhiro Takano, Hitachinaka (JP); Yoshikazu Kawano, Hitachinaka (JP); Masayuki Ogura, Hitachinaka (JP); Shinji Watanabe, Hitachinaka (JP); Haruhisa Fujisawa, Hitachinaka (JP)

(73) Assignee: Hitachi Koki Co., Ltd., Tokyo (JP)

(21) Appl. No.: 13/592,111

(22) Filed: Aug. 22, 2012

(30) Foreign Application Priority Data
Aug. 23, 2011 (JP) 2011-181926
Aug. 23, 2011 (JP) 2011-181927

(51) Int. Cl. H02M 7/44; H02J 7/04; H02J 7/02

(52) U.S. Cl. 363/131; 320/110; 320/106

(57) ABSTRACT

A battery adapter includes an inverter device capable of converting voltage waveform from DC to AC. A first reachable battery and a second rechargeable battery different in shape can be selectively connected to the inverter device. The first rechargeable battery may, for example, a battery pack for use in an electric power tool, and the second rechargeable battery may, for example, a high-capacity lead-acid battery. With the battery adapter, two types of rechargeable batteries can be used as a power source for driving the AC-driven electric power tool. The battery adapter contains therein a microcomputer with which charge/discharge control is implemented.

### CROSS REFERENCE TO RELATED APPLICATION

This application claims priorities from Japanese Patent Application Nos. 2011-181926 and 2011-181927 both filed Aug. 23, 2011. The entire content of these priority applications is incorporated herein by reference.

### TECHNICAL FIELD

The present invention relates to a battery adapter and a power source device employing the same.

### BACKGROUND

As disclosed, for example, in Japanese Patent Application Publication No. 2009-278832, there has been known an inverter device for converting DC voltage to AC voltage. A specific-purpose DC power source is sometimes used to supply the DC voltage subject to DC-to-AC conversion. Such a DC power source may be in the form of a battery pack including, for example, a lithium-ion battery. The battery pack is used, for example, in a power tool as a power source. Generally, replacement of such a specific-purpose DC power source with another type of DC power source cannot be done due to difference in shape and electrical characteristic.

### SUMMARY

In view of the foregoing, it is an object of the invention to provide a battery adapter capable of connecting various types of DC power sources to an inverter device, and also to provide a power source device employing such a battery adapter. For example, the battery adapter according to the invention is capable of selectively connecting a lithium-ion battery and lead-acid battery to the inverter device. These two types of batteries are different in shape and electrical characteristic and used in different battery-driven devices.

In order to attain the above and other objects, the invention provides a battery adapter including a power source device to which one of a first rechargeable battery is selectively connectable. The first rechargeable battery has a first outer shape and a first electric characteristic. A second rechargeable battery has a second outer shape different from the first outer shape.

According to another aspect of the invention, there is provided a power source device including the above-described battery adapter, the above-described second rechargeable battery, and a container accommodating the battery adapter, and the second rechargeable battery. The container has a handle and a wheel.

According to still another aspect of the invention, there is provided a sinusoidal-wave supplying system including the above-described battery adapter, a waveform conversion section configured to convert a first voltage in a form of a first voltage waveform from the first rechargeable battery or the second rechargeable battery to a second voltage in a form of a second voltage waveform, and a sinusoidal-wave adapter connected to the waveform conversion device and configured to convert an input voltage to a sinusoidal-waveform AC voltage. The sinusoidal-wave adapter is further configured to output the input voltage as it is when the input voltage is a sinusoidal-waveform AC voltage.

According to further aspect of the invention, there is provided a voltage supplying system including the above-described power source device and the above-described battery adapter. The first rechargeable battery has a first portion to be identified, the battery adapter has a second portion to be identified different from the first portion to be identified. The power source device determines which of the first rechargeable battery and the battery adapter is connected to the power source device through identification of the first portion and the second portion.

According to still further aspect of the invention, there is provided a battery adapter including a power source device having an input side to which a first rechargeable battery and a second rechargeable battery different in size are selectively connectable, and an output side; and a cigarette socket terminal provided in the output side of the waveform conversion section.

According to yet further aspect of the invention, a power source device may be configured from the above-described waveform conversion section configured to perform conversion of a voltage supplied from a first rechargeable battery or a second rechargeable battery, and the above-described battery adapter.

### BRIEF DESCRIPTION OF THE DRAWINGS

The particular features and advantages of the invention as well as other objects will become apparent from the following description taken in connection with the accompanying drawings, in which:

FIG. 1 is a perspective view showing a power source device according to an embodiment of the invention;

FIG. 2A is a cross-sectional view showing an inverter device and a battery adapter provided in the power source device according to the embodiment of the invention;

FIG. 2B is a cross-sectional view showing a sinusoidal-wave adapter provided in the power source device according to the embodiment of the invention;

FIG. 3 is a plan view showing the power source device according to the embodiment of the invention, in which an upper lid and a middle lid are removed;

FIG. 4A is a perspective view showing an assembly of a battery adapter, inverter, and sinusoidal-wave adapter according to the embodiment of the invention;

FIG. 4B is a plan view showing the assembly of the battery adapter, inverter, and sinusoidal-wave adapter according to the embodiment of the invention;

FIG. 4C is a side view showing the assembly of the battery adapter, inverter, and sinusoidal-wave adapter according to the embodiment of the invention;

FIG. 5 is a side view individually and separately showing the battery adapter, inverter, and sinusoidal-wave adapter according to the embodiment of the invention;

FIG. 6 is a front view individually and separately showing the battery adapter, inverter, and sinusoidal-wave adapter according to the embodiment of the invention;

FIG. 7 is a perspective view individually and separately showing the battery adapter, inverter, and sinusoidal-wave adapter according to the embodiment of the invention;

FIG. 8 is a perspective view showing an inverter device according to the embodiment of the invention;

FIG. 9 is a rear view showing the inverter device according to the embodiment of the invention;

FIG. 10 is a rear view individually and separately showing the battery adapter and the inverter device;

FIG. 11 is a circuit diagram of the battery adapter rand the inverter device;

FIGS. 12A-12G are explanatory diagrams for illustrating changes in voltage waveform in the circuit shown in in FIG. 11;

FIG. 13 is a circuit diagram of the sinusoidal-wave adapter according to the embodiment of the invention;

FIG. 14 is a graphical representation for illustrating a battery charging control according to the embodiment of the invention;

FIG. 15A is a table showing a relationship between a battery temperature and a charge voltage;

FIG. 15B is a table showing a relationship between charging time and a charge completion time in relation to a battery temperature;

FIG. 16 is a part of flowchart illustrating a battery charge/discharge control according to the embodiment of the invention;

FIG. 17 is a remaining part of flowchart illustrating a battery charge/discharge control according to the embodiment of the invention;

FIG. 18 is a flowchart illustrating an output control of the inverter device according to the embodiment of the invention; and

FIG. 19 is a flowchart illustrating an output control of the sinusoidal-wave adapter according to the embodiment of the invention.

### DETAILED DESCRIPTION

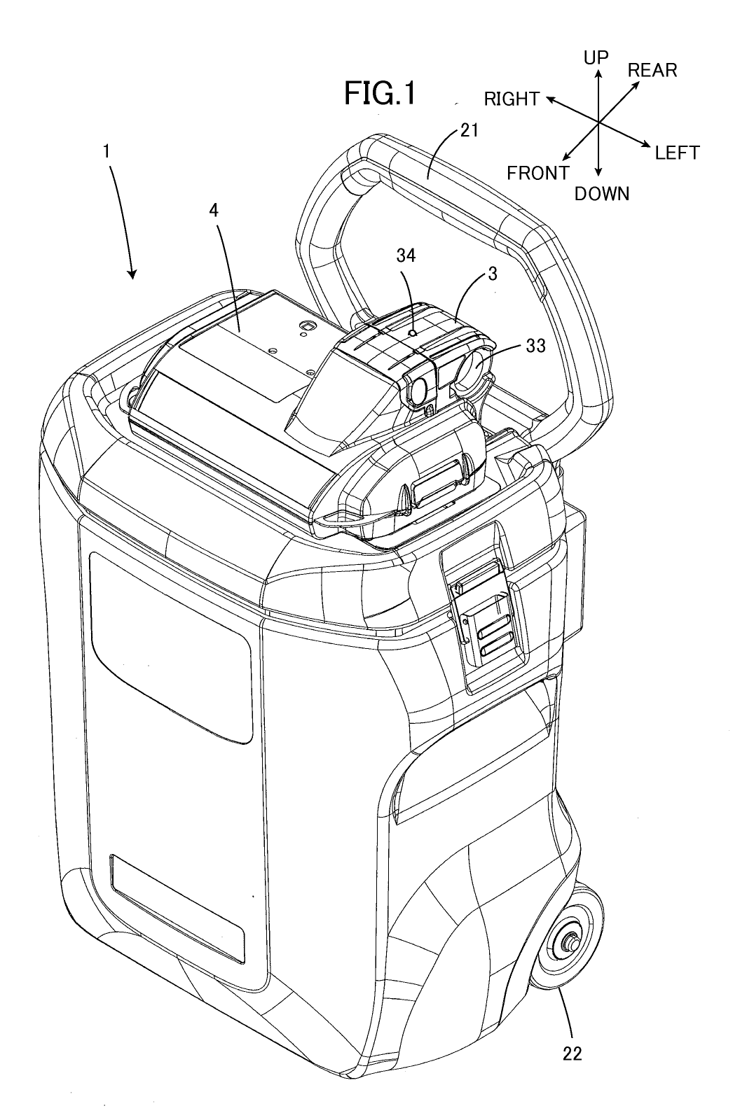

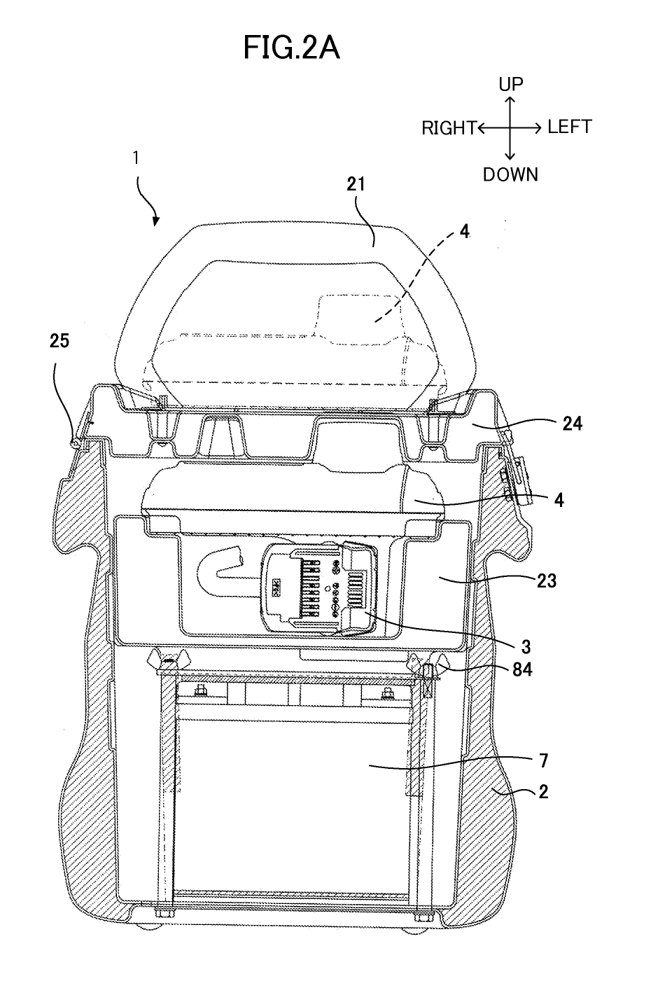

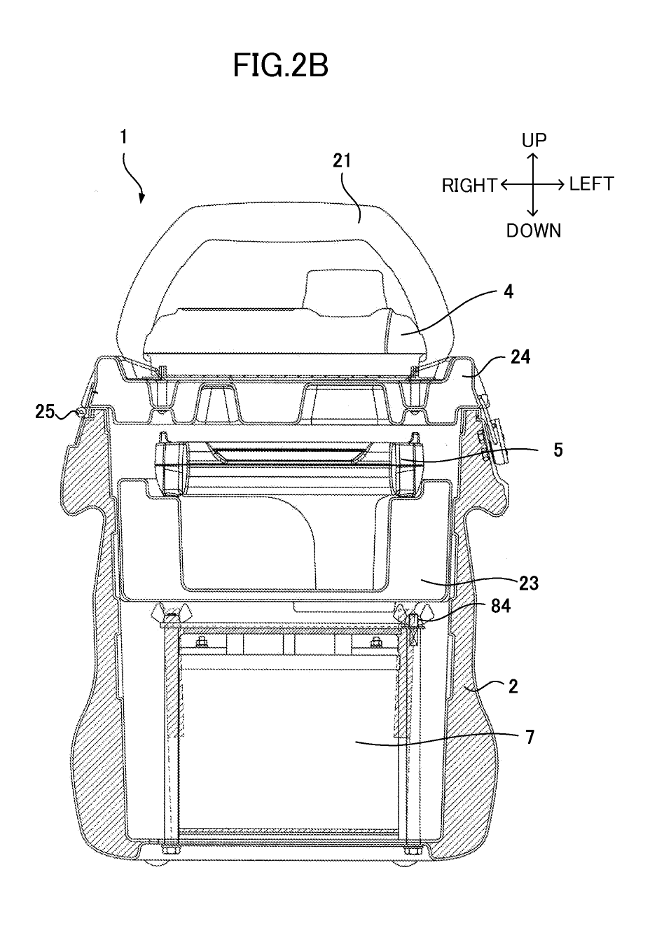

A power source device 1 according to an embodiment of the invention will be described while referring to the accompanying drawings. As shown in FIG. 1, the power source device 1 includes a container 2, a battery adapter 3, and an inverter device 4. Although not appearing in FIG. 1, the power source device 1 further includes a sinusoidal-wave adapter 5 accommodated in the container 2. The inverter device 4 is disposed either in the upper portion of the container 2 as shown in FIG. 1 or above an upper lid 24 as shown in FIG. 2A. The battery adapter 3 is inserted into the inverter device 4.

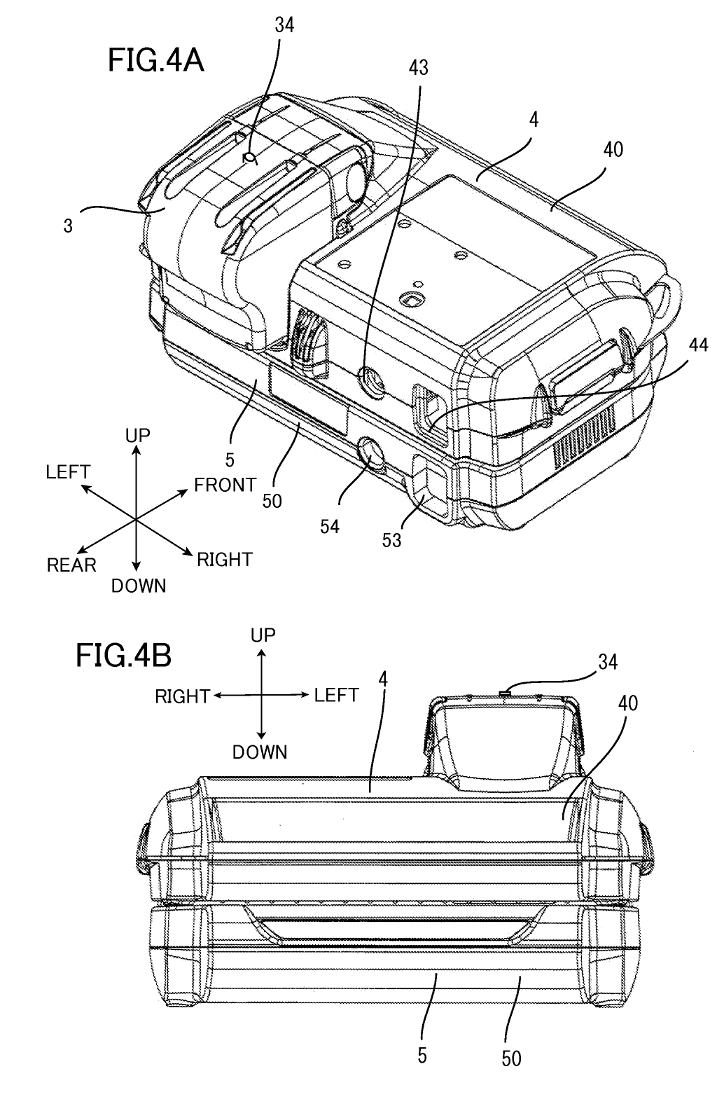

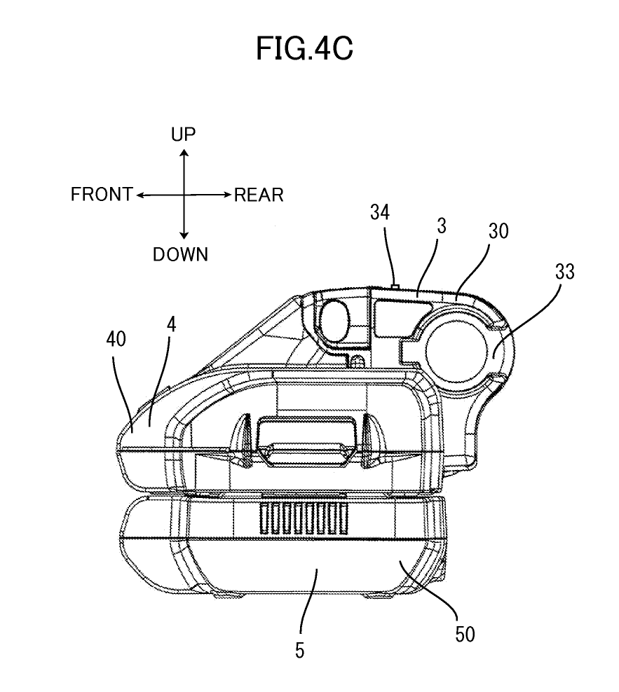

As shown in FIG. 4A, when using the power source device 1, the inverter device 4 is placed above the sinusoidal-wave adapter 5. The inverter device 4 converts a DC voltage to an AC voltage having a rectangular waveform. The DC voltage is supplied to the inverter device 4 from a battery, such as lead-acid battery, through the battery adapter 3. The inverter device 4 is used, for example, in an electrically-driven power tool containing an AC motor therein. The sinusoidal-wave adapter 5 can be used as a part of a power source not only in an AC-driven power tool but also other types of AC-driven electric equipment.

As shown in FIGS. 1 and 2A, the container 2 includes a handle 21, wheels 22, an inner lid 23, an upper lid 24, and a hinge 25. The upper lid 24 is pivotally movable about the hinge 25 so as to be opened and closed. In the closed condition, the free end of the upper lid 24 (right side in FIG. 2A) is latched for not allowing the upper lid 24 to be freely opened. The inner lid 23 is provided in a space below the upper lid 24. The inner lid 23 is generally of a U-shaped in cross-section, providing an accommodating space. A lead-acid battery 7 is disposed in a space below the inner lid 23 and fixed to the bottom wall of the container 2 using wing bolts 84.

As shown in FIG. 2A, the battery adapter 3 can be accommodated in the accommodating space of the inner lid 23. The inverter device 4 can be accommodated in a space above the inner lid 23. In lieu of the inverter device 4, the sinusoidal-wave adapter 5 may be accommodated in the space above the inner lid 23. If it is the case, the inverter device 4 is fixedly secured to the upper lid 24 as shown by a dotted line in FIG. 2A. The sinusoidal-wave adapter 5 enables an equipment to be driven by the AC voltage of sinusoidal waveform.

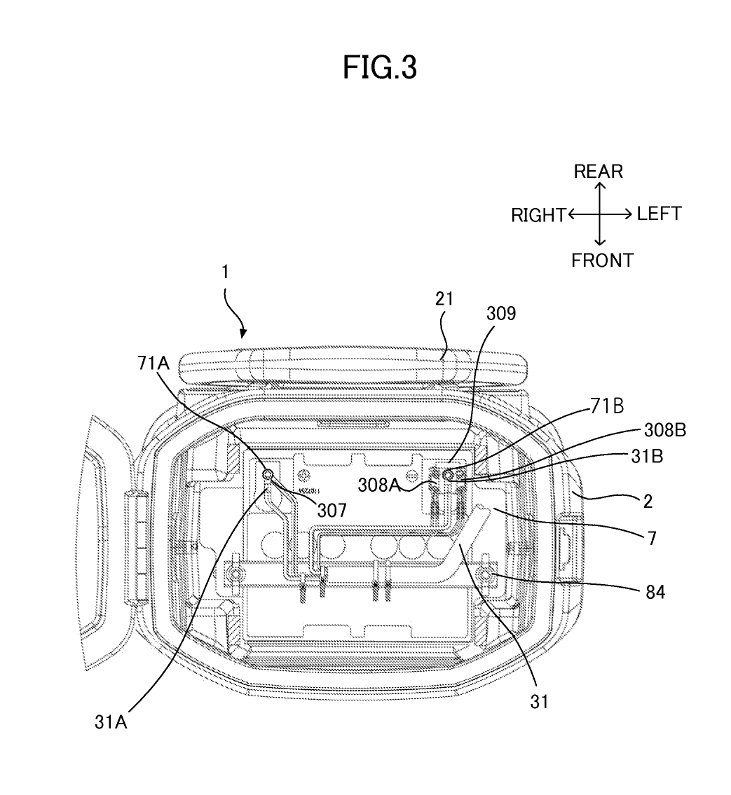

In this embodiment, a 12V lead-acid secondary battery as used in an uninterruptible power supply (UPS) is used as the DC power source of the inverter device 4. A car battery mounted on a vehicle can be used instead. As shown in FIG. 3, the lead-acid battery 7 has a positive terminal 71A and a negative terminal 71B. To the positive terminal 71A, a thermistor 307 is connected using a bolt. A copper holder 309 is fixedly connected to the negative terminal 71B using a bolt. A pair of thermal protectors 308A and 308B is bonded to the copper holder 309 with silicon.

As will be described more in detail, the thermistor 307 is provided for detecting a temperature of the lead-acid battery 7. The thermal protector 308A is used to interrupt an output path of a cigarette socket 33 whereas the thermal protector 308B is used to interrupt a charge path.

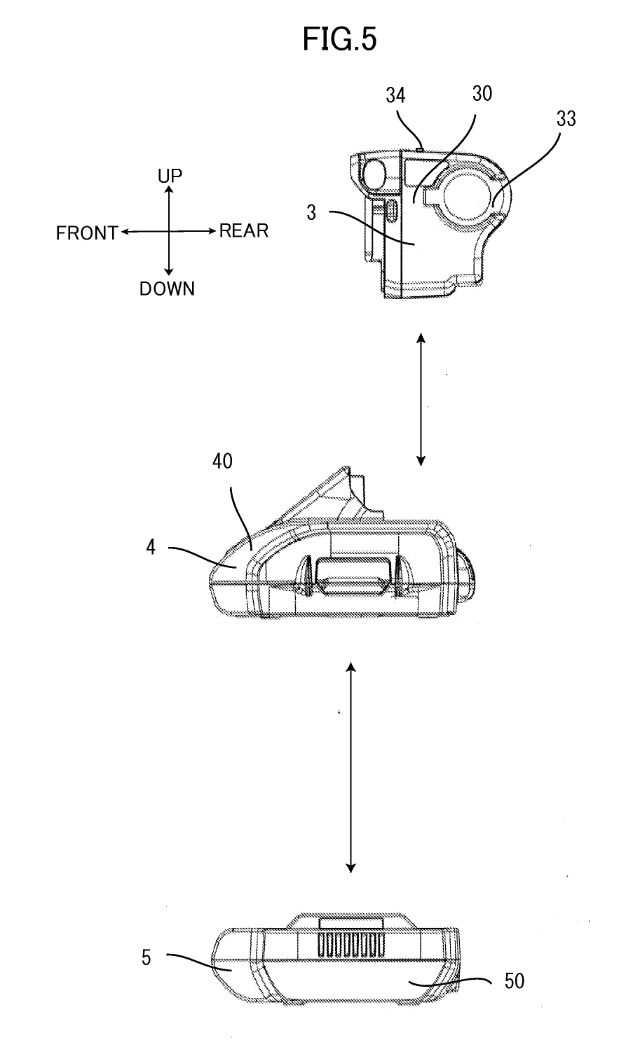

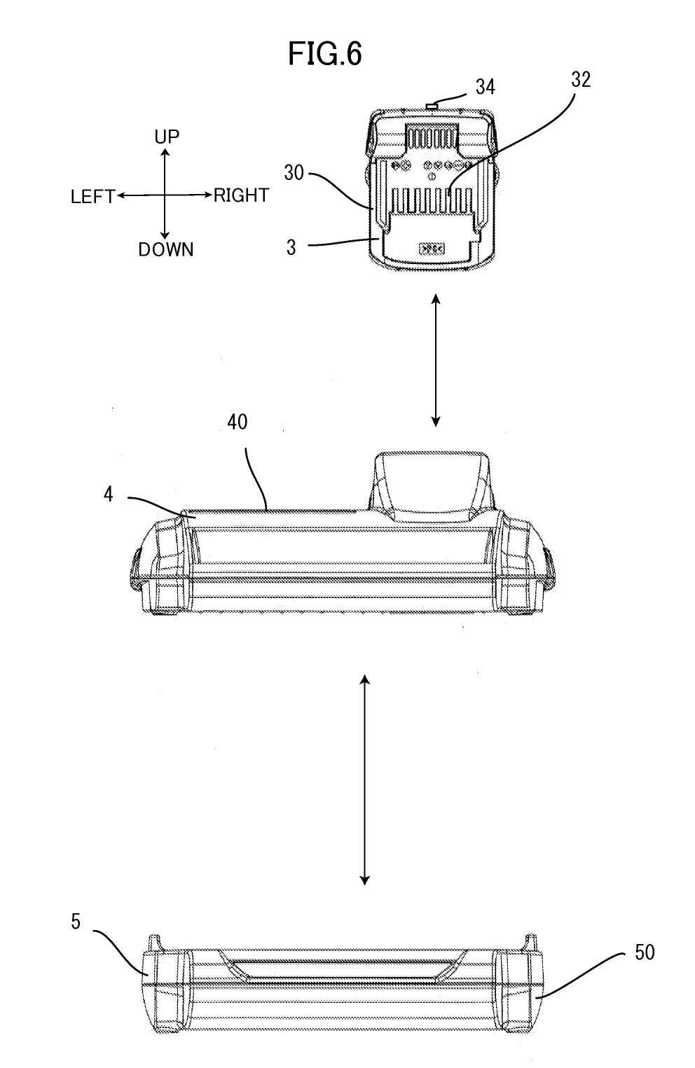

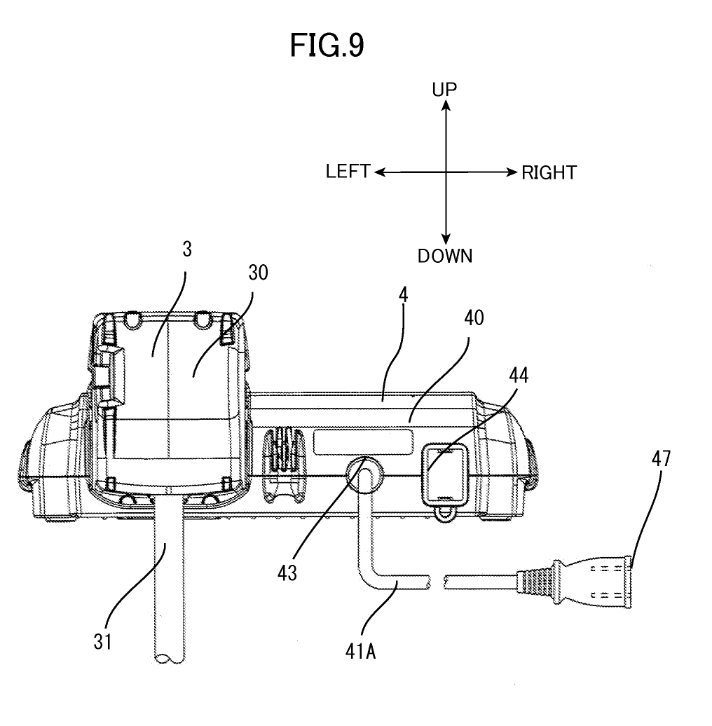

FIGS. 4A to 4C show an assembled unit of the battery adapter 3, inverter device 4 and sinusoidal-wave adapter 5. FIGS. 5 to 7 show an unassembled state of the battery adapter 5, inverter device 4 and sinusoidal-wave adapter 5. The battery adapter 3 includes a case 30, and a connection cable 31 (see FIG. 9). To the outer surface of the case 30, provided are an LED 34 (FIG. 4A), a cigarette socket plug 33 (FIG. 4C), and terminals 32A through 32G (FIG. 6). As shown in FIG. 3, the terminals 31A and 31B are provided at one end of the connection cable 31 and connected to the terminals 71A and 71B, respectively. As such, the battery adapter 3 is capable of being supplied with 12V DC voltage from the lead-acid battery 7. Also, the lead-acid battery 7 is connected to the cigarette socket plug 33, allowing 12V DC voltage to be supplied from the cigarette socket plug 33.

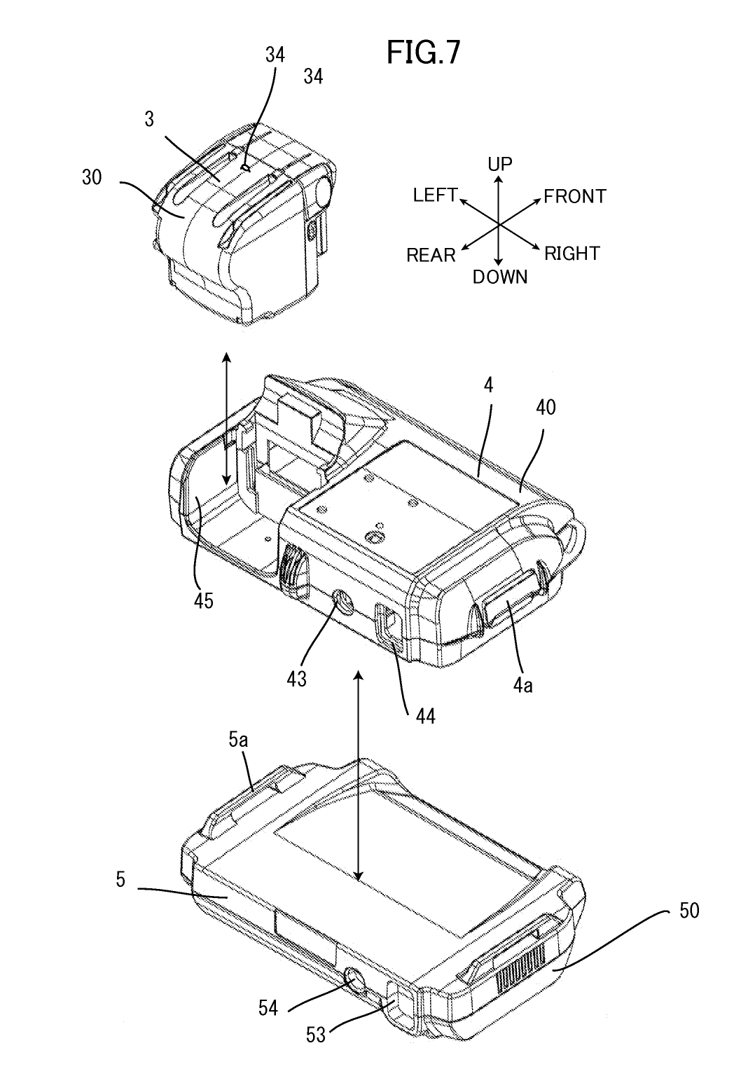

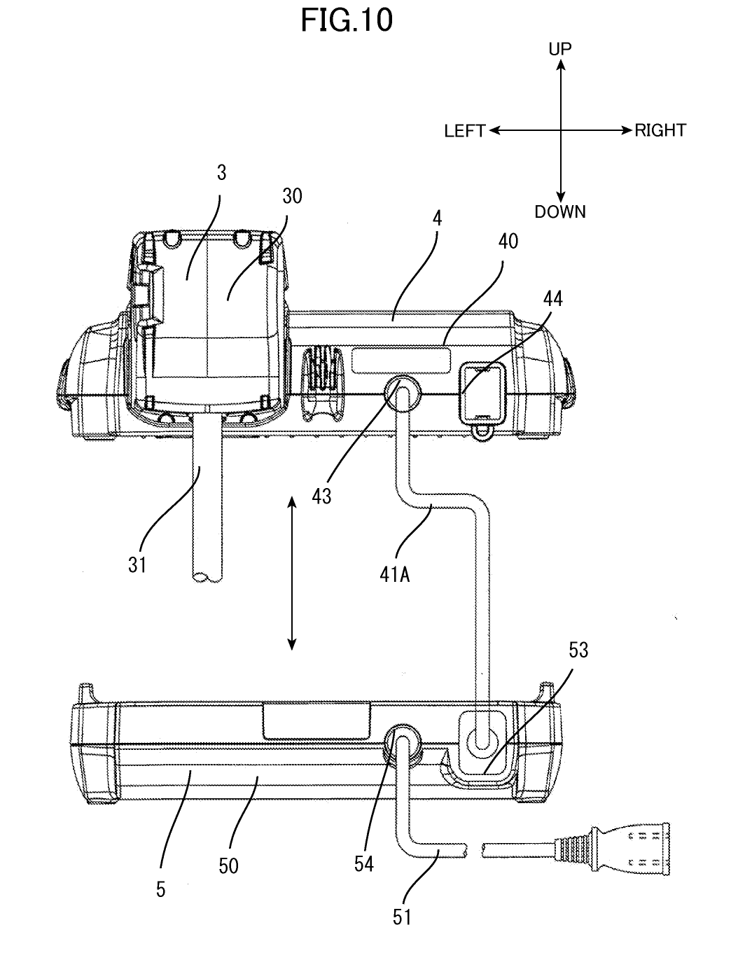

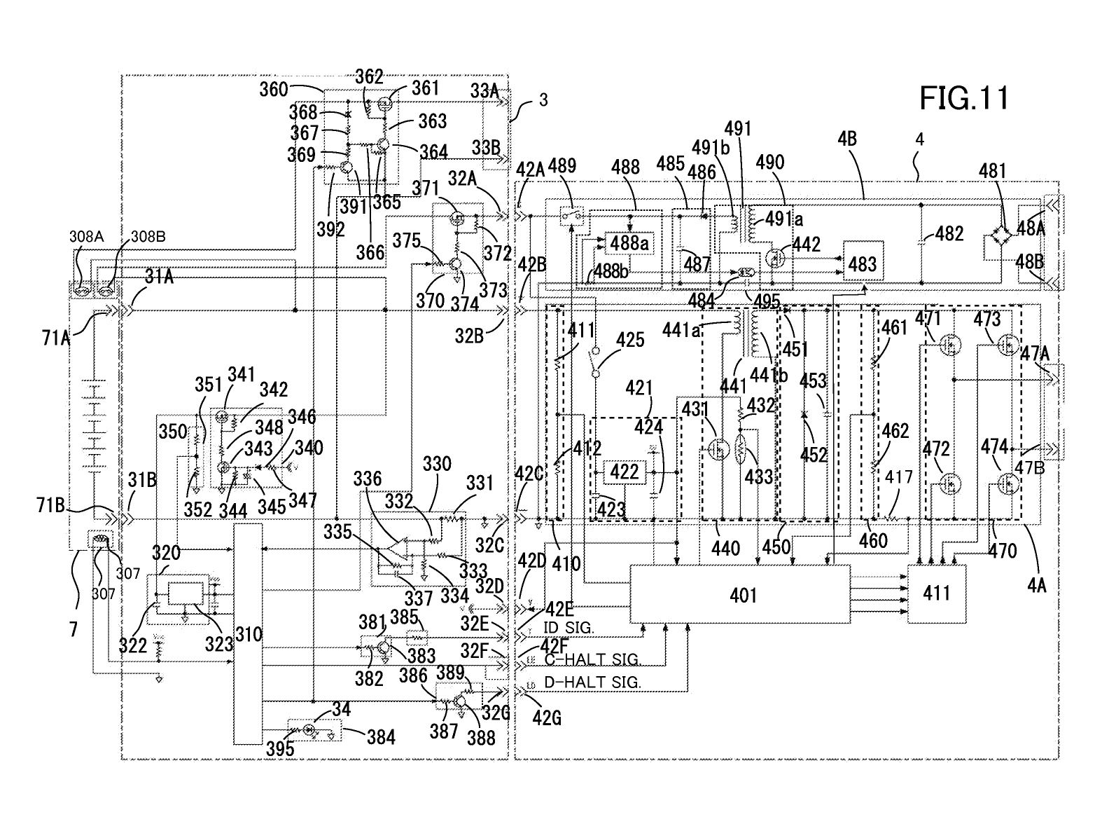

As shown in FIG. 7, the inverter device 4 has a case 40 in which formed are a recess 45 and cable connection ports 43, 44. Although not illustrated in FIG. 7, a plurality of terminals 42A to 42G (which will be collectively denoted by reference numeral 42) is provided in the recess 45. The terminals 42A to 43G appear in the circuit diagram shown in FIG. 11. A latch 4a is formed in each of the right and left sides of the inverter device 4 so as to be engageable with engagement portion 5a formed in each of the right and left inner portions of the sinusoidal-wave adapter 5. The inverter device 4 and the sinusoidal-wave adapter 5 can be fixed to be integral with each other by the engagements of the latches 4a with the engagement portions 5a. Another latch similar to the latch 5a is provided in the upper lid 24 so that the inverter device 4 can be fixed to the upper lid 24.

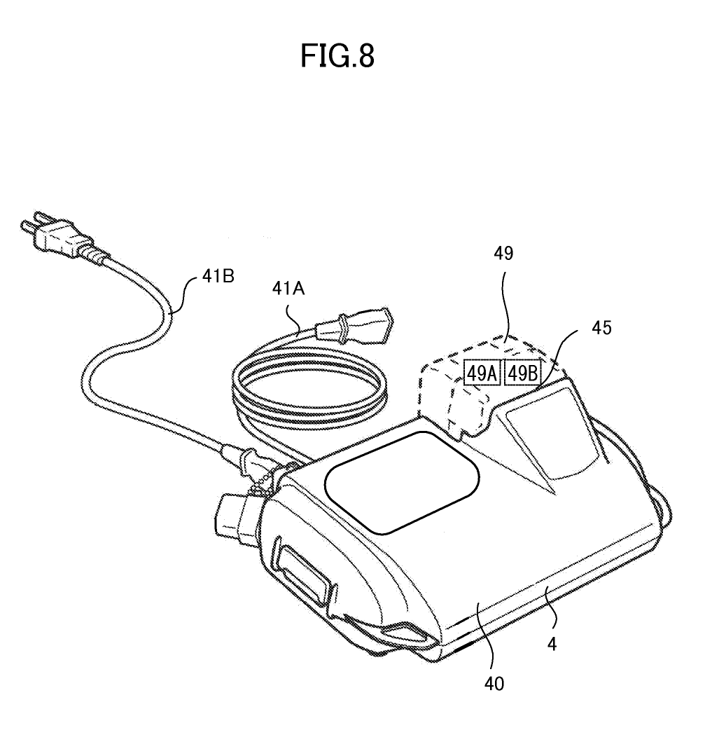

As shown in FIG. 8, the battery pack 49 for use in an electrically-driven power tool is insertable into the recess 45 formed in the inverter device 4. The battery pack 49 containing rechargeable batteries therein is used as a power source of the power tool and shaped to be insertable into the recess 45 of the inverter device 45. One example of the battery pack 49 contains 14.4V, 3.0 Ah lithium-ion batteries. The battery pack 49 further contains a discrimination resistor 49A and a thermistor 49B in a circuit provided internally of the battery pack 49.

The battery adapter 3 is so shaped as to be insertable into the recess 45 of the inverter device 4 as shown in FIGS. 4A to 4C. Specifically, the battery adapter 3 and the connecting portion of the battery pack 49 to be inserted into the recess 45 are shaped substantially identically. Insertion of the battery adapter 3 into the recess 45 of the inverter device 4 electrically connects the terminals 32 (32A to 32G) of the battery adapter 3 with the terminals 42 (42A to 42G) of the inverter device 4, respectively. By this connection, the lead-acid battery 7 is connected via the battery adapter 3 to the inverter device 4, allowing power to be supplied to the inverter device 4. The cigarette socket plug is provided in the side wall continuous to the case 30.

A set of terminals 47 (47A and 47B) and another set of terminals 48 (48A and 48B) of the inverter device 4 as shown in FIG. 11 are provided interiorly of cable connection ports 43 and 44, respectively. The cable connection ports 43 and 44 are connected to cables 41A and 41B (see FIG. 8), respectively. In use, the cable 41B is connected to a commercial AC 100V power supply for allowing the lead-acid battery 7 to be charged. The cable 41A is connected to the cable connection port 43 so as not to be detachable. On the other hand, the cable 41B is detachably connected to the cable connection port 44. Incidentally, the commercial power supply to which the cable 31B is connected is not limited to the AC 100V but any other AC voltage is available.

As shown in FIG. 4A, the sinusoidal-wave adapter 5 includes a casing 50 in which cable connection ports 53 and 54 are formed. Terminals 57 and 58 are provided interiorly of the cable connection ports 53 and 54, respectively. As shown in FIG. 10, the cable connection ports 53 and 54 are connected to cables 51 and 41A, respectively. The cable 41A connects the terminal 47 and the terminal 57. Each of the cable connection ports 44 and 53 is provided with a male-type terminal The cable connection port 44 is configured to receive and fit the female-type terminal of the cable 41A. The cable connection port 53 is configured to receive and fit the female-type terminal of the cable 41A. Another end of the cable 51 is in the form of a female-type terminal plug to which a power source cord of an electrically driven power tool or other electrical equipment can be connected.

FIG. 11 shows an electrical circuit of the lead-acid battery 7, battery adapter 3 and inverter device 4. The battery adapter 3 is connected to the lead-acid battery 7, and the inverter device 4 is in turn connected to the battery adapter 3.

The battery adapter 3 has an input-side positive terminal 31A, input-side negative terminal 31B, output-side positive terminal 32B, output-side negative terminal 32C, and terminals 32A to 32G. The input-side positive terminal 31A and input-side negative terminal 31B are connected to the positive terminal 71A and negative terminal 71B of the lead-acid battery 7, respectively. By these connections, the DC voltage from the lead-acid battery 7 is applied to the battery adapter 3. The input-side positive terminal 31A and input-side negative terminal 31B are connected to the output-side positive terminal 32B and output-side negative terminal 32C of the battery adapter 3, respectively. As such, the output-side negative terminal 32C of the battery adapter 3 is connected to the negative terminal of the lead-acid battery 7. With such connections, the DC voltage supplied from the lead-acid battery 7 is applied to the inverter device 4 through the positive terminal 32B and negative terminal 32C.

The battery adapter 3 includes a microprocessor 310, constant voltage circuit 320, charge current detecting circuit 330, power consumption suppressing circuit 340, power source voltage detecting circuit 350, output halting circuit 360, charge circuit 370, charge timer reset circuit 381, discriminating resistor 385, residual charge amount displaying circuit 384, discharge halting circuit 386, and temperature detecting circuit 307A connected to a thermistor 307. The thermistor 307 is disposed in contact with or in proximity with the lead-acid battery 7 to detect the temperature of the same.

The power source voltage detecting circuit 350 is configured from resistors 350 and 351 connected in series between the input-side positive terminal 31A and input-side negative terminal 31B. A node between the resistors 350 and 351 is connected to the microprocessor 351 to apply a voltage developed across the resistor 351.

The power consumption suppressing circuit 340 is configured from FETs 341, 343, resistors 342, 344, 347, 348, diode 346, and capacitor 345. The low power consumption circuit 340 is connected between the input-side positive terminal 31A of the battery adapter 3 and the constant voltage circuit 320. More specifically, the FET 341 has a source connected to the input-side positive terminal 31A, a drain connected to the constant voltage circuit 320, and a gate connected to the drain of the FET 343 via the resistor 348. The resistor 342 is connected between the source and the gage of the FET 341.

When the voltage from the inverter device 4 is applied to the low power consumption circuit 340 via the terminal 32D, the FET 343 is rendered ON and the FET 341 is also rendered ON. As a result, the output voltage from the lead-acid battery 7 is applied to the constant voltage circuit 320. On the other hand, when the voltage from the inverter device 4 is not applied to the low power consumption circuit 340, the FET 343 is OFF which in turn renders the FET 341 OFF. As such, the output voltage from the lead-acid battery 7 is not applied to the constant voltage circuit 320. Accordingly, the microcomputer 310 is not placed in an operable condition. In this way, when the inverter device 4 is not operating, the lead-acid battery 7 does not supply power to the battery adapter 3. With such a configuration, power of the lead-acid battery 7 is not consumed in vain.

The constant voltage circuit 320 includes a three-terminal regulator 323, and an oscillation suppressing capacitor 322. The constant voltage circuit 320 functions to convert the voltage supplied from the lead-acid battery 7 to a predetermined voltage (for example, 5V) and the converted voltage is applied to the microcomputer 310 and other components to be operable or to activate.

The charge current detecting circuit 330 includes resistors 331 to 335, an operational amplifier 336, and a capacitor 337. The resistor 331 is connected between the input-side terminal 31B and the output-side terminal 32C. The charge current detecting circuit 330 operates to amplify the current flowing in the resistor 331 with the operational amplifier 336 and the resulting current is applied to the microcomputer 310. Thus, the microcomputer 310 is capable of measuring the current flowing in the resistor 331.

The charge timer reset circuit 381 includes a resistor 382 and a transistor 383. The transistor 383 has a collector connected to the inverter device 4 (terminal 42E) via the identification resistor 385 and the terminal 32E, and an emitter connected to the negative-side terminal 32C. In response to the high-level output signal issued from the microcomputer 310, the transistor 383 is rendered ON and a reset signal is applied to the inverter device 4. The microcomputer 310 outputs the identification signal to the inverter device 4 via the charge timer reset circuit 381, identification resistor 385, and terminal 32e. The identification resistor 285 has a resistance specific to the lead-acid battery 7 being used. In response to the identification signal, the inverter device 4 is capable of knowing electrical characteristic of the lead-acid battery 7, such as a voltage. The resistance of the identification resistor 385 is set to a value different from the resistance of the identification resistor 49A of the battery pack 49. Specifically, due the different resistances imparted upon the identification resistors 385 and 49A, the identification signal identifying the battery adapter 3 and output via the identification resistor 385 is different from the identification signal identifying the battery pack 49 and output via the identification resistor 49A. Hence, the inverter device 4 is capable of determining whether the battery adapter 3 is connected or the battery pack 49 is connected based on the identification signal received.

The charge halt circuit 386 includes a resistor 387, a transistor 388, and a resistor 389. The transistor 388 has a collector connected to the inverter device 4 via the resistor 389 and the terminal 32G, and an emitter connected to the negative terminal 32C. When the microcomputer 310 determined that the output voltage from the lead-acid battery 7 falls below a predetermined level in response to the output from the power source voltage detecting circuit 350, the microcomputer 310 outputs a high-level signal to the discharge halt circuit 386. In response to the high-level signal output from the microcomputer 310, the transistor 388 is rendered ON, allowing a discharge halt signal (LD signal) to be output to the inverter device 4. On the other hand, when the microcomputer 310 determines that the output voltage from the lead-acid battery 7 has not yet fallen below the predetermined level, that is, when the microcomputer 310 determines that discharging can be continued, the microcomputer 310 outputs a low-level signal to the discharge halt circuit 286. Then, the transistor 388 turns to OFF and the discharge halt signal is not produced. The signal output to the discharge halt circuit 386 is also output to an output halt circuit 360 which will be described later. When the discharge halt signal is output from the discharge halt circuit 386, the output halt circuit 360 interrupts the cigarette socket plug 33 from the lead-acid battery 7, so that the voltage from the cigarette socket plug 33 is not available. The microcomputer 310 is connected to the terminal 32F and the charge halt signal (LE signal) is output to the inverter device 4 via the terminal 32F.

The residual amount display circuit 384 includes a resistor 395 and an LED 34. The LED 34 is lit with the residual amount of the lead-acid battery, i.e., the voltage detected by the power source voltage detecting circuit 350. In accordance with the embodiment of the invention, when the microcomputer 301 determines that the voltage detected by the power source voltage detecting circuit 350 is equal to or greater than 70% of the maximum voltage of the lead-acid battery 7, the microcomputer 301 controls the LED 34 to continuously light. When the microcomputer 301 determined that the detected voltage by the power source voltage detecting circuit 350 falls between 30% and 70% of the maximum voltage of the lead-acid battery 7 (equal to or greater than 30% but less than 70%), the LED 34 is controlled to flicker at a first frequency. When the microcomputer 301 determines that the detected voltage is less than 30% of the maximum voltage of the lead-acid battery 7, the LED 34 is controlled to flicker at a second frequency higher than the first frequency. As such, the user can readily recognize the residual amount of the lead-acid battery 7 from the lighting state of the LED 34.

The cigarette socket plug 33 has a pair of two terminals 33A and 33B. The positive terminal 33A is connected to the positive terminal 71A of the lead-acid battery 7 via the terminal 31A and the output halt circuit 360. The counterpart negative terminal 33B of the cigarette socket plug 3 is connected to the negative terminal 71B of the lead-acid battery 7. The output of the lead-acid battery 7 can be simultaneously derived from both the cigarette socket terminals 33A and 33B and the terminals 32B and 32C. Specifically, on one hand, DC 12V can be output from the cigarette socket terminals 33 and on the other hand, rectangular-wave 100V can be output from the inverter device 4. Both outputs can be available simultaneously.

The output halt circuit 360 is connected between the positive terminal 31A of the lead-acid battery 7 and the terminal 33A of the cigarette socket plug 33. The output halt circuit 360 is configured from an FET 361, resistors 362, 363, 365 to 367, 369 and 392, transistors 264 and 391, and a Zenor diode 368. The transistor 391 has a base connected to the microcomputer 310. The FET 361 has a source connected to the terminal 31A and a drain connected to the terminal 33A. In response to a high-level signal applied to the base of the transistor 391 by the microcomputer 310, the transistor 391 is rendered ON and the transistor 364 is rendered OFF. This in turn renders the FET 361 OFF, so that the terminal 31A and the terminal 33A are disconnected one from the other. On the other hand, in response to a low-level signal applied to the base of the transistor 391 by the microcomputer 310, the transistor 392 is rendered OFF, allowing a current to flow in the path defined by the Zenor diode 368 and the resistors 367, 366 and 365. The transistor 364 is thus rendered ON and the FET 36 is rendered ON, thereby connecting the terminals 31A and 33A. Accordingly, the output voltage from the lead-acid battery 7 can be derived from the terminals 33A and 33B of the cigarette socket plug 33. In this manner, the DC voltage of the lead-acid battery 7 can be derived from the cigarette socket plug 33. It can be appreciated that an electrical equipment provided with a cigarette socket can be used if the electrical equipment is inserted into the battery adapter 3. When the voltage across the lead-acid battery 7 is lowered, further discharge from the lead-acid battery 7 is halted by the output halt circuit 360. With such a configuration, over-discharge of the battery can be prevented. When the voltage across the lead-acid battery 7 is equal to or greater than the predetermined value, the transistor 364 is rendered ON and the FET 361 is in turn rendered ON, so that the power is supplied to the cigarette socket plug 33.

The charge circuit 370 is connected to the FET 371, resistors 372, 373 and 375, and a transistor 374. The transistor 374 has a base connected to the output terminal of the microcomputer 310 via the resistor 375. The FET 371 has a drain connected to both the positive terminal 31A of the lead-acid battery 7 and the constant voltage circuit 320, and a source connected to the output-side terminal 32A of the battery adapter 3. The lead-acid battery 7 is charged by the voltage applied to the terminals 32A and 32B from the inverter device 4. When the lead-acid battery 7 is charged, the microcomputer 310 outputs a high-level signal to the base of the transistor 374 to thereby render the transistor 374 ON. When the transistor 374 is rendered ON, the FET 371 is also rendered ON, thereby forming a charge circuit to allow the lead-acid battery 7 to be charged. On the other hand, when the microcomputer 310 applies a low-level signal to the base of the transistor 374, the FET 371 is rendered OFF to interrupt the charge path. Hence, charging the lead-acid battery 7 is halted.

A thermistor 307 is disposed in the vicinity of the lead-acid battery 7. In this embodiment, the thermistor 307 is disposed in the vicinity of the positive terminal 71A by fixing the thermistor 307 with a bolt. Because the thermistor 307 is disposed in the vicinity of the thermistor 307, the battery temperature can be accurately detected. Further, the thermistor 307 is firmly fixed using a clamper, such as bolt, it is unlikely that the thermistor 307 is detached or removed due to external force, such as vibrations. The microcomputer 310 is supplied with information about the temperature of the lead-acid battery 7 by the thermistor 307 and the temperature detecting section 307A. The constant voltage circuit 320 supplies power to the temperature detecting section 307A.

A pair of thermal protectors 308A and 308B is fixedly secured using bolts in the vicinity of the negative terminal 71B of the lead-acid battery 7. The thermal protectors 308A and 308B are held by a copper holder 309 and fixedly secured thereto using silicon. The holder 309 is fixedly secured to the negative terminal 71B of the lead-acid battery 7 using a bolt. The thermal protector 308A is disposed in an output path lead to the cigarette socket 33 (terminals 33A and 33B) and the lead-acid battery 7. Another thermal protector 308B is disposed in a charge path extending to the lead-acid battery 7 and in a power supply path (switch 425). While in the above-described embodiment, the thermal protectors 308A and 308B are described as being separate members from the battery adapter 3 and the lead-acid battery 7, the protectors may be a part of the battery adapter 3 or a part of the lead-acid battery 7.

The thermal protectors 308A and 308B are brought to an open state when the battery temperature becomes high, say, more than 65 Centigrade, due to malfunction of the battery. When it is the case, the above-described path is interrupted, ensuring the charge/discharge to halt in the case of battery malfunction. When the thermal protector 308A is brought to an open state, no signal is applied to the gate of the FET 364, so that the FET 361 is rendered OFF and the output to the cigarette socket plug 33 is interrupted. On the other hand, when the counterpart thermal protector 308B is brought to an open state, the charge path between the charge section 4B and the lead-acid battery 7 is interrupted. Further, power supply to the constant voltage circuit 421 via a switch 425 (to be described later) of the inverter device 4 is interrupted, so that a control section 401 (to be described later) is no longer operable and the inverter device 4 halts its operation.

Generally, the battery temperature does not increase significantly during a long-time continuous usage of the same. Deterioration of the battery and malfunction of the battery is liable to occur when the battery is used under a low or high temperature circumstance. The embodiment is adopts a condition for a temperature in which a battery is allowed to be used. The thermistor 307 is provided so that the power supply to the inverter device 4 is implemented under the temperature control. The pair of thermal protectors 308A and 308B is provided for thermal protection at the time of output control to the cigarette socket plug 33 and at the time of charging the battery.

As shown in FIG. 3, the power source device 1 is so structured as to directly attach a single thermistor 307 to the positive terminal 71A of the lead-acid battery 7 and to directly attach the pair of thermal protectors 308A and 308B to the positive terminal 71A for the purpose of enhancing accuracy of the temperature control. Further, for the purpose of detecting the temperature with high accuracy, the pair of thermal protectors is directly bonded to the copper holder 309 using silicon and secured to the terminal portion using a bolt and a nut. With such a structure, the thermal protectors 308A and 308b and the thermistor 307 are prevented from being detached or disconnected from the attached portions, which may otherwise occur due to external force or vibrations yielded at the time of conveyance or transportation. Also, the temperature control can be implemented with high accuracy.

While the thermal protectors 308A and 308B are illustrated in the vicinity of the positive terminal 71A, and the thermistor 307 in the vicinity of the negative terminal 71B in FIG. 11, it is to be noted that the illustration in FIG. 11 is not intended to show the physical positional relation. As described above, FIG. 3 shows the physical positional relation with respect to the thermistor 307 and the thermal protectors 308A and 308B. Alternatively, the thermistor 307 may be directly attached to the negative terminal 71B of the lead-acid battery 7, and the thermal protectors 308A and 308B to the positive terminal 71A thereof.

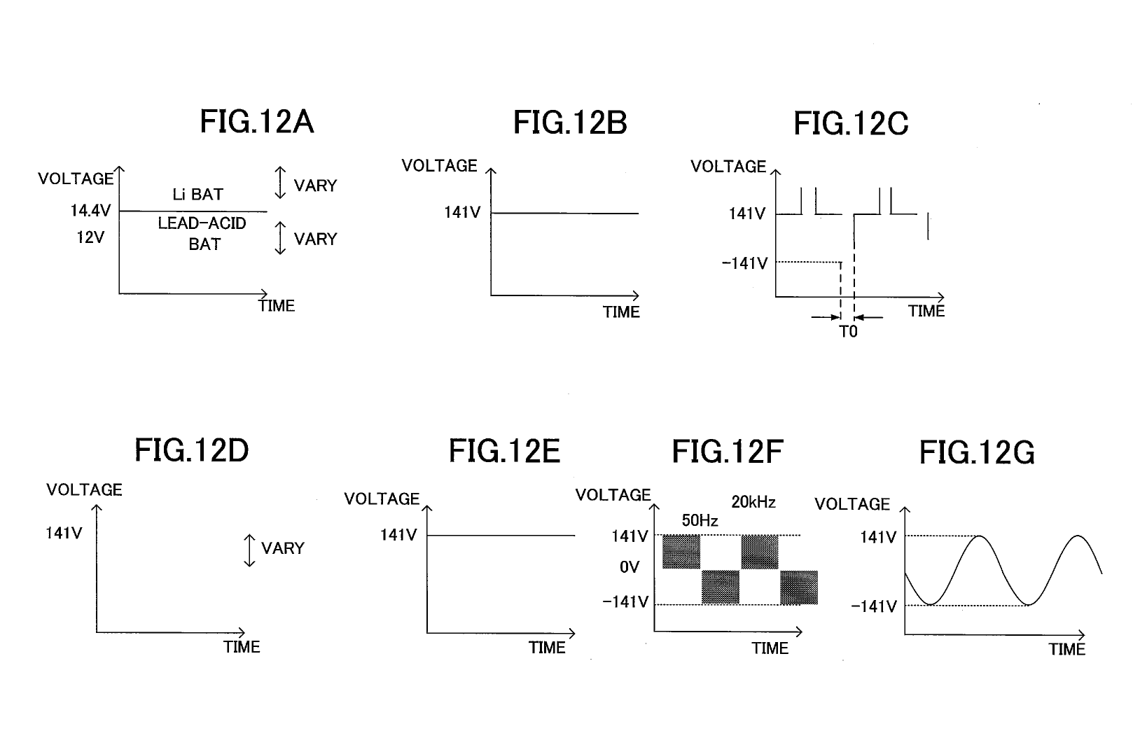

The invertor 4 is supplied with a DC voltage from the lead-acid battery 7 via the battery adapter 3 (see FIG. 12A). While boosting the supplied DC voltage (see FIG. 12B), the inverter device 4 converts the DC voltage to a rectangular-wave voltage (see FIG. 12C). The sinusoidal-wave adapter 5 first rectifies the rectangular-wave voltage to be a DC voltage (see FIG. 12D) and the resultant DC voltage is changed to a relevant level DC voltage upon performing a DC-to-AC conversion, transforming the resultant AC voltage and then performing a AC-to-DC conversion (see FIG. 12E). The finally obtained DC voltage is converted to a pulsating voltage (see FIG. 12F), and thereafter the pulsating voltage is converted to a sinusoidal-wave voltage (see FIG. 12G). The sinusoidal-wave voltage thus obtained can be output to a precision machine via the terminals 5A and 5B (outlets of the commercial AC power supply).

As shown in FIG. 11, the inverter 3 includes a discharge section 4A and a charge section 4B. The discharge section 4A includes a battery voltage detecting section 410, a switch 425, a constant voltage circuit 421, a boost circuit 440, rectifying/smoothing circuit 450, a boosted voltage detecting circuit 460, an inverter circuit 470, a current detecting resistor 417, a PWM signal output section 411, and a control section 401. The discharge section 4A converts the DC voltage applied to the terminals 42B and 42C to a rectangular-wave AC voltage and outputs the latter from the terminals 47A and 47B.

The battery voltage detecting section 410 includes battery voltage detecting resistors 411 and 412 which are connected in series between the positive terminal 42B and negative terminal 42C. The voltage of the battery (which is the lead-acid battery 7 connected to the battery adapter 3 in the embodiment shown in FIG. 11) is voltage-divided by the battery voltage detecting resistors 411 and 412 and the divided voltage is applied to the control section 401. A battery pack 49 (see FIG. 8) for use as a power source of a power tool can be connected to the terminals 32B and 32C.

The power source switch 425 and the constant voltage circuit 421 are connected in series between the positive terminal 42B and the control section 401. The constant voltage circuit 421 includes a three-terminal regulator 422 and oscillation suppression capacitors 423 and 424. When the power source switch 425 is turned ON by the user, the voltage from the battery adapter 3 (lead-acid battery 7) is converted to a DC voltage (for example, 5V) and the resultant voltage is applied to the control section 401 as a drive power. When the power source switch 425 is turned OFF, the driving power is no longer supplied to the control section 401, causing the overall inverter device 4 is rendered OFF.

The boosting circuit 440 includes a transformer 441, an FET 431, a resistor 432, and a thermistor 433. The transformer 441 is composed of a primary winding 441a and a secondary winding 441b. The primary winding 441a is connected between the positive terminal 42B and negative terminal 42C. The FET 431 is connected between the primary winding 441a of the transformer 441 and the negative terminal 42C. The FET 431 has a gate to which a first PWM signal supplied from the control section 401 is applied. The FET 431 is rendered ON or OFF in response to the first PWM signal. Depending upon switching actions of the FET 431, the DC power supplied from the battery adapter 3 (or battery pack 49) is converted to AC power for applying to the primary winding 441a of the of the transformer 441. The AC power applied to the primary winding 441a of the transformer 441 is transformed depending upon a ratio of the number of turns in the secondary winding to the number of turns in the primary winding, and the resultant AC power is output from the secondary winding 441b. The thermistor 433 is used to detect the temperature of the FET 431. When the control section 401 determines that the temperature of the FET 431 is higher than a predetermined temperature, the FET 431 is rendered OFF in response to the first PWM signal, thereby interrupting a current from flowing in the transformer 441 in order to prevent circuit components, particularly FET 431, from being damaged by high temperature.

The rectifying/smoothing circuit 450 includes a rectifying diode 451 and a smoothing capacitor 453. The rectifying/smoothing circuit 450 operates to rectify and smoothen the AC power stepped up by the transformer 441 and outputs DC power.

The boosted voltage detecting circuit 460 includes resistors 461 and 462 connected in series, and operates to detect the stepped-up DC voltage (a voltage developed across the smoothing capacitor, which is, for example, 141 volt) output from the rectifying/smoothing circuit 450 and outputs a voltage divided by the resistors 461 and 462 to the control section 401.

The inverter circuit 470 includes four FETs 471-474. A first pair of serially connected FETs 471 and 472 and a second pair of serially connected FETs 473 and 474 are connected in parallel to the smoothing capacitor 453. More specifically, the FET 471 has a drain connected to the cathodes of the rectifying diodes 451 and 452, and a source connected to the drain of the FET 472. The FET 473 has a drain connected to the cathodes of the rectifying diodes 451 and 452, and a source connected to the drain of the FET 474.

Further, the source of FET 471 and the drain of FET 472 are connected to the output terminal 47A, and the source of FET 473 and the drain of FET 474 are connected to the output terminal 47B. The output terminals 47A and 47B are configured to be connected to the terminals 52A and 52B of the sinusoidal-wave adapter, respectively. A second PWM signal is output from a PWM signal output section 411 and applied to the gates of the FETs 471-474 to render the latter ON or OFF. The switching actions of the FETs 471-474 convert the DC voltage output from the rectifying/smoothing circuit 450 to an AC voltage of rectangular waveform (for example, AC 100V), and the converted AC voltage is applied to the sinusoidal-wave adapter 5.

The current detecting resistor 417 is connected between the sources of FETs 472, 474 and the negative-side terminal 42C. The high-voltage side of the current detecting resistor 417 is connected to the control section 401. With such a configuration, the current detecting resistor 417 detects the current flowing in the inverter device 4 based on a voltage drop in the resistor and outputs the dropped voltage to the control section 401.

The control section 401 outputs the first PWM signal to the gate of the FET 431 so that the boosted voltage reaches a target effective value (for example, 141 volt) based on the boosted voltage detected by the boosted voltage detecting section 460. Further, the control section 401 outputs the second PWM signal to the gates of the FETs 471-474 via the PWM signal output section 411 so that an AC voltage including a target effective value (for example AC 100 volt) is output to the terminal 47. In accordance with the present embodiment, the control section 401 outputs the second PWM signal such that a first pair of FETs 471, 474 and a second pair of FETs 472, 473 are alternately switched to ON and OFF. Stated differently, the control section 401 controls the gate voltage of the FET 431 so as to obtain the target boosted voltage based on the feedback information about the boosted voltage detected by the boosted voltage detecting section 460.

The control section 401 determines whether or not the lead-acid battery 7 connected to the battery adapter 3 has been over-discharged based on the battery voltage detected by the battery voltage detecting section 410. More specifically, when the battery voltage detected by the battery voltage detecting section 410 is smaller than a predetermined discharge voltage, the control section 401 determines that the lead-acid battery 7 is over-discharged and outputs the first and second PWM signals to halt the output to the inverter device 4. This means that output of at least one of the first and second PWM signals is halted. The control section 401 outputs the first and second PWM signals to halt the output to the terminal 47 in response to the discharge halt signal (LD signal) received from the signal terminal 42G. This means that output of at least one of the first and second PWM signals is halted.

Further, the control section 401 determines whether or not an over-current is flowing based on the current (or voltage) detected by the current detecting resistor 417. More specifically, when the current detected by the current detecting resistor 417 has exceeded an over-current determinative threshold value of the FETs 471-474 configuring the inverter circuit 470, the control section 401 outputs the first PWM signal to the gate of the FET 431 to halt the switching action of the FET 431, and also outputs the second PWM signal to the gates of the FETs 471-474 to halt the switching actions of the FETs 471-474. By this control, power supply to the AC motor 31 is halted, enabling to prevent malfunction which may occur in the AC motor 31 or inverter circuit 470 (particularly FETs 471-474) due to the over-current. As a modification, switching actions of one of the FET 431 and FETs 471-474 may be halted to achieve the above-described goal.

The charge section 4B includes a rectifying circuit 481, a smoothing capacitor 482, an FET driver IC 483, a voltage stepping down circuit 490, a rectifying/smoothing circuit 485, a feedback control section 488, a switch 489, and a capacitor 495. The rectifying circuit 481 is connected between the terminals 48A and 48B and rectifies an AC voltage applied between the terminals 48A and 48B. The smoothing capacitor 482 performs smoothing of the AC voltage being rectified by the rectifying circuit 481. As shown in FIG. 8, a cable 41B is connected to the terminal 48 to apply a commercial AC voltage thereto. The voltage stepping down circuit 490 includes a transformer 491 and an FET 442. The transformer 491 is configured from a primary winding 491a and a secondary winding 491b. The primary winding 491a is connected between the positive-side terminal 48A and the negative-side terminal 48B. The FET 442 is connected between the primary winding 491a of the transformer 491 and the negative-side terminal 48B. The FET 442 has a gate to which a third PWM signal fed from the FET driver IC 483 is applied. The FET 442 performs switching actions in response to the third PWM signal, thereby converting the supplied DC voltage to an AC voltage. The resultant AC voltage is applied to the primary winding 491a of the transformer 491. The AC voltage applied to the primary winding 491a is transformed depending upon a ratio of the number of turns in the secondary winding 491b to the number of turns in the primary winding 491a, and the stepped-up (or stepped-down) AC voltage is output from the secondary winding 491b. The microprocessor 401 applies the identification signal inputted from the terminal 42E to the FET driver IC 483. Based on the identification signal, the FET driver IC 483 generates the third PWM signal with a duty ratio corresponding to the lead-acid battery 7. In this manner, a voltage corresponding to the lead-acid battery 7 is supplied from the charge section 4B.

The rectifying/smoothing circuit 485 includes a rectifying diode 486 and a smoothing capacitor 487. The rectifying/smoothing circuit 485 rectifies and smoothens the stepped-down AC output from the transformer 491 and outputs a DC voltage to be applied to the battery adapter 3. Specifically, the positive side of the rectifying/smoothing circuit 385 is connected to the terminal 42A and the negative side thereof to the terminal 42C. When the switch 489 is turned ON, the DC voltage being rectified and smoothened by the rectifying/smoothing circuit 485 is output to the battery adapter 4 via the terminal 42A.

The feedback control section 488 includes a feedback circuit 488a and a resistor 488b. The feedback circuit 488a detects a current flowing in the resistor 488b and sends a control signal to the FET driver IC 483 via a photo-coupler 484 depending upon the level of the current detected by the feedback circuit 488a. Specifically, when the current flowing in the resistor 488b is reduced, the feedback control circuit 488a controls the FET driver IC 483 to transmit the PWM signal with an increased duty ratio whereas when the current flowing in the resistor 488b is increased, the feedback control circuit 488a controls the FET driver IC 483 to transmit the PWM signal with a decreased duty ratio.

The switch 489 is connected between the terminal 42A and the rectifying/smoothing circuit 485 and switches the charging from ON to OFF or vice versa. The control section 401 performs measurement of a charging period of time tc from the start of charge. When the charging period of time exceeds a predetermined period of time tcf, the control section 401 turns the switch 489 OFF to thereby halt the charging. The inverter device 4 is configured to use a specific battery pack 49, such as a battery pack for used in an electrically-driven power tool. The predetermined period of time tcf is determined to such a time duration that prevents the battery pack 49 from being over-charged. The control section 401 also turns the switch 489 OFF in response to the charge halt signal (LD signal) applied from the terminal 42E.

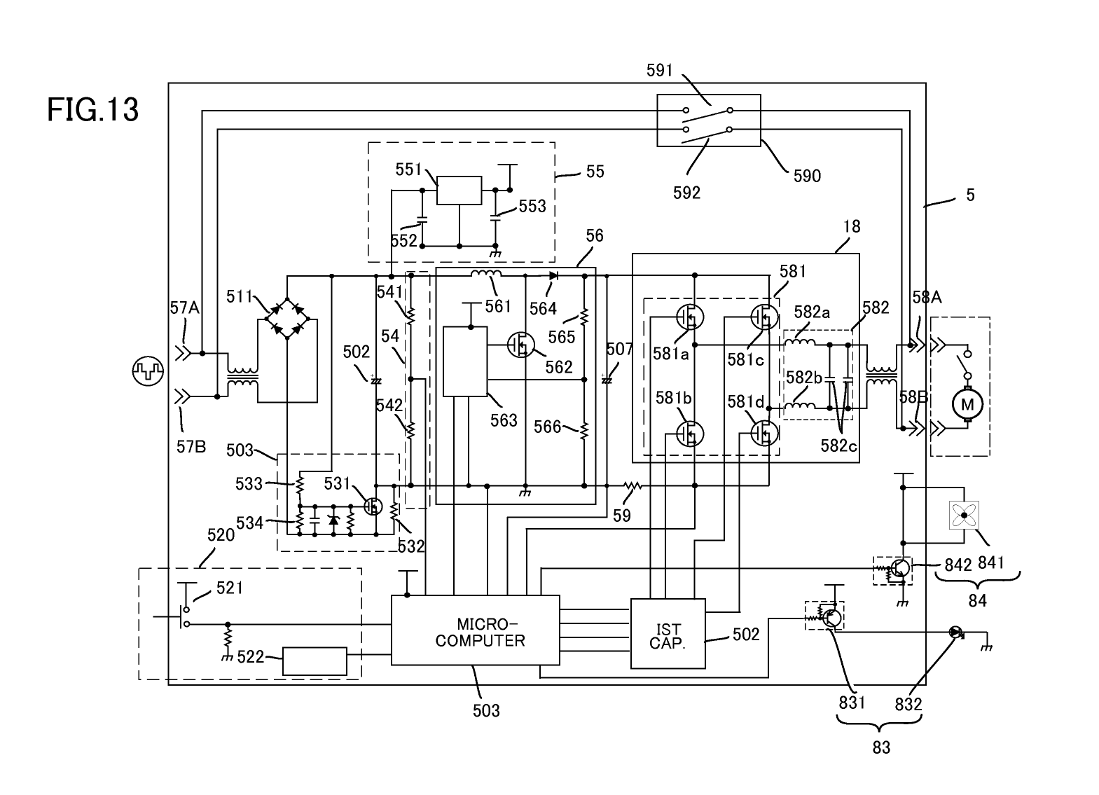

Next, the circuit configuration of the sinusoidal-wave adapter 5 will be described. FIG. 13 is a circuit diagram showing the sinusoidal-wave adapter 5.

As shown in FIG. 13, the sinusoidal-wave adapter 5 includes input terminals 57 (57A and 57B), output terminals 58 (58A and 58B), a rectifying circuit 511, a first smoothing capacitor 502, a rush current prevention circuit 503, a voltage detecting circuit 54, an auxiliary power source 55, a boosting circuit 56, a second smoothing capacitor 507, an inverter circuit 18, a current detecting resistor 59, a driver IC 502, a microcomputer 503, a frequency changeover circuit 520, a display section 83, a fan mechanism 84, and a relay circuit 590.

The rectifying circuit 511 and the first smoothing capacitor 502 rectifies and smoothens the rectangular-wave voltage (see FIG. 12C) input from the inverter device 4, and outputs a DC voltage equal to the maximum level of the voltage inputted from the inverter device 4 as shown in FIGS. 12D and 12E.

The rush current prevention circuit 503 is provided for preventing a rush current from flowing in the sinusoidal-wave adapter 5 when the latter is powered. The rush current prevention circuit 503 basically includes an FET 531, a rush current prevention resistor 532, and resistors 533 and 534 provided for voltage dividing purpose. The rush current prevention resistor 532 has a resistance large enough to prevent a large current to flow in the first smoothing capacitor 502.

The FET 531 is maintained OFF up to when the divided voltage by the resistors 533 and 534 of the output voltage from the rectifying circuit 511 and the first smoothing capacitor 502 has reached the gate voltage of the FET 531 starting from the time when the inverter device 4 is powered (i.e., when the sinusoidal-wave adapter 5 starts operating). In this case, the rush current prevention resistor 532 and the first smoothing capacitor 502 are connected in series, increasing an overall impedance. For this reason, the rush current is prevented from flowing in the sinusoidal-wave adapter 5.

On the other hand, when the divided voltage on the resistor 534 has reached to the gate voltage of the FET 531, the FET 531 is rendered ON and a current does no longer flow in the rush current prevention resistor 532. Because the rush current is no longer outstanding at the time when the FET 531 is rendered ON, there is no power consumption in the rush current prevention resistor 532 once the FET 531 is rendered ON.

The voltage detecting circuit 54 is configured from voltage detecting resistors 541 and 542 connected in series. The output voltage from the rectifying circuit 511 and the first smoothing capacitor 502, i.e., the charged voltage in the first smoothing capacitor 502, is divided by the resistors 541 and 542 and the divided voltage is applied to the microcomputer 503.

He auxiliary power source 55 includes a three-terminal regulator 551, and oscillation prevention capacitors 552 and 553. The auxiliary power source 55 converts the voltage output from the rectifying circuit 551 and the first smoothing capacitor 502 to a predetermined DC voltage (for example, DC 5V), and the resultant voltage is applied to the microcomputer 503 as a driving voltage.

The boosting circuit 56 includes a coil 561, an FET 562, a switching IC 53, a rectifying diode 564, and voltage detecting resistors 565 and 566.

Switching actions (ON and OFF) of the FET 562 performed under the aegis of the switching IC 563 outputs pulsating voltage from the coil 561. The pulsating voltage is subject to rectification and smoothing by the rectifying diode 564 and the second smoothing capacitor 507 to provide a DC voltage. In accordance with the present embodiment, as shown in FIG. 12E, DC voltage of 141 volt is output from the boosting circuit 56 and the second smoothing capacitor 507. The voltage detecting resistors 565 and 566 operate to monitor the voltage developed across the second smoothing capacitor 507 and feedback the voltage to the switching IC 563. The switching IC 563 renders the FET 562 ON and OFF so that the voltage developed across the second smoothing capacitor 507 is held to 141 volt.

The inverter circuit 18 includes an inverter portion 581 and a filter portion 582. The inverter portion 581 is configured from four FETs 581a-581d. The FET 581a has a drain connected to the cathode of the rectifying diode 564, and a source connected to the drain of the FET 58 lb. The FET 581c has a d rain connected to the cathode of the rectifying diode 564 and a source connected to the drain of the FET 581d. To each of the gates of the FETs 581a-581d, the second PWM signal is applied by the driver IC 502 for the FETs 591a-581d to perform the switching actions. The switching actions performed by the FETs 581a-581d convert the DC voltage output from the boosting circuit 56 and the second smoothing capacitor 507 is converted to pulsating voltage as shown in FIG. 12F.

The filter portion 582 includes coils 582a and 582b, and a capacitor 582c. To the coil 582a, connected are the source of the FET 581 and the drain of the FET 581b, whereas to the coil 582b, connected are the source of the FET 581c and the drain of the FET 581d. The pulsating voltage output from the inverter portion 581 (FETs 581a-581d) is converted to a sinusoidal-wave voltage through the filter portion 582 as shown in FIG. 12G.

The current detecting resistor 59 is connected between the sources of FETs 581b and 581d and ground. The high voltage side terminal of the current detecting resistor 59 is connected to the microcomputer 503. With such a configuration, the current detecting resistor 59 detects the current flowing in the inverter circuit 18 (sinusoidal-wave adapter 5), and applies the corresponding voltage to the microcomputer 503.

In response to the voltage detected by the voltage detecting circuit 54, the microcomputer 503 controls the ON/OFF operations of the switching IC 53. The switching IC 563 performs PWM control over the FET 562 so that a predetermined DC voltage (141 volt in this embodiment) is output from the boosting circuit 56 and the second smoothing capacitor 507, that is, the boosted voltage in the second smoothing capacitor 507 is brought to 141 volt.

The microcomputer 503 outputs the second PWM signal to the gates of the FETs 581a-581d via the driver IC 502. The second PWM signal output from the microcomputer 50 is such a signal that causes the inverter circuit 508 to output a pulsating voltage having an effective value 100 volt. In the present embodiment, the microcomputer 503 normally outputs the second PWM signal that alternately renders the first set of FETs 581a and 581d and the second set of the FETs 581b and 581c ON and OFF at 100% in the duty ratio. The second PWM signal is such a signal that the respective FETs perform ON/OFF switching at a switching frequency of 20 kHz. The output frequency can be changed by the frequency change-over circuit 522 (to be described later) to, for example, 50 Hz as shown in FIG. 12F.

The microcomputer 503 as used in the present embodiment carries out monitoring of the input voltage, determination as to whether or not boosting of voltage is needed, and soft start at the time when the sinusoidal-wave adapter 5 starts its operation.

The microcomputer 503 carries out the monitoring of the input voltage in such a manner that operations of the voltage boosting circuit 56 and the inverter circuit 508 are halted in the case where the maximum value of the rectangular waveform voltage inputted from the inverter device 4 is out of a first range (equal to or greater than 99 volt and equal to or smaller than 169 volt). With such an operation, likelihood that the FETs and other elements contained in the sinusoidal-wave adapter 5 are damaged can be relieved.

In making determination as to whether or not the boosting of voltage is needed, the microcomputer 503 halts the operation of the boosting circuit 56 when the maximum value of the rectangular voltage falls within the second range (from 127 volt to 141 volt in the present embodiment). Because the boosting circuit 56 is operated based on such a determination, the boosting circuit 56 is prevented from being operated in vain and unnecessary power consumption can be prevented.

In the soft start, when the current flowing in the inverter circuit 508 is greater than a predetermined value (in the present embodiment, 10 Ampere) over a predetermined period of time from the start of operation of the inverter circuit 508 (in the present embodiment, 100 microseconds), the duty ratio of the second PWM signal is lowered to 50%. Thereafter, the duty ratio is reverted to 100% in the duration of 2.5 seconds. As such, a large amount of current is prevented from being flowed in the sinusoidal-wave adapter 5 and the inverter device 4.

The frequency change-over circuit 520 includes a switch 521 and an EEPROM 522. By depressing the switch 221 for a predetermined period of time (in the present embodiment, 3 seconds), the frequency of the sinusoidal-wave voltage output from the sinusoidal-wave adapter 5 is switchable between 50 Hz and 60 Hz. More specifically, when the switch 221 is depressed, a HIGH level frequency change-over signal is applied to the microcomputer 503 from the sinusoidal-wave adapter 5. In order for the microcomputer 503 to change-over the frequency of the sinusoidal-wave voltage output from the sinusoidal-wave adapter 5, the microcomputer 503 changes the second PWM signal depending upon the frequency change-over signal. The EEPROM 522 stores the frequency at the time when the operation of the microcomputer 503 is halted, that is, when the power supply from the inverter device 4 is halted. At the time of the start of the next operation, the microcomputer 503 outputs the second PWM signal depending upon the frequency stored in the EEPROM 522.

A display portion 83 includes a transistor 831 and an LED 832. The transistor 831 is rendered ON in response to the LOW signal output from the microcomputer 503 and then the LED 832 is lit or flickered. Although not illustrated in FIG. 13, the transistor 831 is actually a group of transistors including a transistor for a 50 Hz, green light LED, a transistor for a 50 Hz, red light LED, a transistor for a 60 Hz green light LED, and a transistor for a 60 Hz red light LED. Also, the LED 832 is actually a group of the 50 Hz, green light LED, 50 Hz, red light LED, 60 Hz green light LED, and 60 Hz red light LED. The corresponding transistor and LED are connected so that the former drives the latter. The microcomputer 503 outputs signals to the display portion 83 so that relevant LED or LEDs are lit to indicate the status of the sinusoidal-wave adapter 5.

When the frequency is set to 50 Hz by the frequency change-over circuit 520, the 50 Hz, green LED is lit. When the frequency is set to 60 Hz by the frequency change-over circuit 520, the 60 Hz, green LED is lit. When the current detected by the current detecting resistor 520 is 4 A or more, the red LED for the relevant frequency being set is lit whereas when the current detected by the current detecting resistor 520 is 5 Ampere or more, the red LED for the relevant frequency being set is flickered.

Although not illustrated, a temperature detecting means, such as a thermistor, is disposed in proximity with the FET 562 to detect the temperature of the FET 562. When the temperature detected by the thermistor is 100 Centigrade or more, the green LED for the relevant frequency being set is flickered.

When the frequency is changed-over by the frequency change-over circuit 520, the green and red LEDs for the frequency being changed are flickered at an interval of 0.5 second for a duration of 3 seconds, and subsequently flickered at an interval of 0.2 second for a duration of 2 seconds, and then only the green LED is lit continuously. It is to be noted that when both the green LED and the red LED are lit simultaneously, the mixed light is seen to be an orange color.

A fan mechanism 84 primarily includes a cooling fan 841 and a transistor 842. The microcomputer 503 outputs an ON signal to the transistor 842 when the microcomputer 503 is powered. The transistor 842 is rendered ON in response to the ON signal, thereby driving the cooling fan 841.

The relay circuit 591 includes switches 591 and 592. The switch 591 is interconnected between the positive-side terminals 57A and 58A, and another switch 592 is interconnected between the negative-side terminals 57B and 58B. The ON/OFFF switching actions of the switches 591 and 592 are controlled by the microcomputer 503. The relay circuit 590 is rendered ON when a voltage in the form of a sinusoidal-wave is applied to the sinusoidal-wave adapter 5 and outputs the input voltage as it is. At this time, the boosting circuit 56 and the inverter circuit 18 are disabled, so that power consumption can be suppressed.

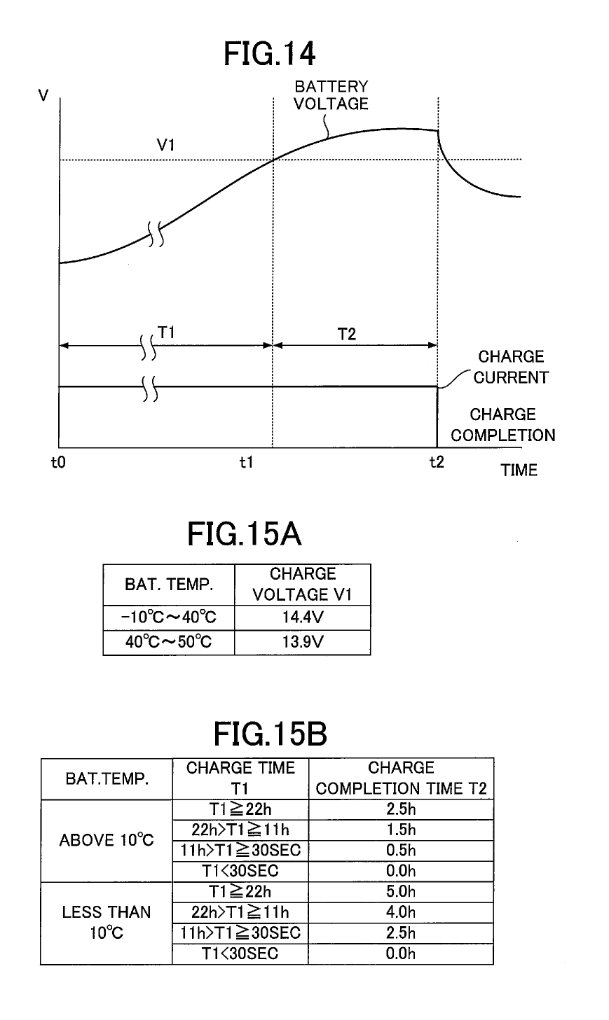

FIG. 14 is a graphical representation illustrating how the lead-acid battery 7 is controlled at the time of charging by the battery adapter 3. The axis of abscissa represents charging time in which tO is a charge start time. The axis of ordinate represents charging current and battery voltage. The voltage developed across the resistor 352 indicative of the voltage across the lead-acid battery 7 is applied to the microcomputer 310. The microcomputer 310 computes a duration of time T1 from charge start time t0 to time t2 at which the voltage across the lead-acid battery has reached to voltage V1. A duration of time T2 corresponding to the measured duration of time T1 is set by the microcomputer 310, and the latter halts charging the lead-acid battery 7 at time t2 when the duration of time T2 has expired from time t1. As described above, the inverter device 4 is configured to automatically turn off the switch 489 when charging time tc has reached to a predetermined duration of time tcf. The lead-acid battery 7 in accordance with this embodiment has a charging capacity of 38 Ah larger than the charging capacity of 3.0 Ah of the battery pack 49. The predetermined duration of time tcf is set to protect the battery pack 49 from being over-charged. The battery pack 49 using the lithium battery contains a protection IC therein for protecting the lithium-ion battery from being over-charted and over-discharged and also for preventing an overcurrent from flowing in the lithium battery. When, for example, the lithium battery is brought to an over-charged condition, a charge stop signal is output from the battery pack 49 and applied to the inverter device 4, thereby stopping charging the battery. In this manner, the battery pack 49 with the lithium battery containing therein is configured so as not to be over-charged, over-discharged and in an over-current flowing condition. Even if the protection IC does not function properly for some reasons, charging the lithium battery is forcibly stopped as the switch 489 is turned off after expiration of the charge completion time tcf (reference value) stored in the control section 401. The predetermined duration of time tcf is not long enough to fully charge the lead-acid battery 7 having a larger capacity than the lithium battery pack 49. To solve this problem, the microcomputer 310 issues a reset signal to the inverter device 4 through a timer reset circuit 381 prior to expiration of the predetermined duration of time tcf. Thus, the charging time tc in the inverter device 4 is reset to zero. A second re set signal is issued prior to expiration of the predetermined duration of time tcf from the issuance of the first reset signal. In this manner, the microcomputer 310 repeatedly issues the reset signals at an interval shorter than the predetermined duration of time tcf until time t2. The issuance of the reset signals by the microcomputer 310 does not allow the switch 489 to turn off and enables the lead-acid battery 7 to be charged until time t2. In lieu of repeatedly issuing the reset signals from the microcomputer 310, the timer reset circuit 381 may issue the reset signals to deactivate the charge timer when judgment is made such that the battery being charged is the lead-acid battery.

As shown in FIG. 15A, the charge voltage V1 of the lead-acid battery 7 takes different values depending upon the temperature as detected by the thermistor 307 and upon the temperature detected by the temperature detecting means 307A. As shown in FIG. 15B, the relation between the duration of time T1 and duration of time T2 is determined depending upon the temperature of the lead-acid battery 7 as detected by the thermistor 307 (temperature detecting portion 307A).

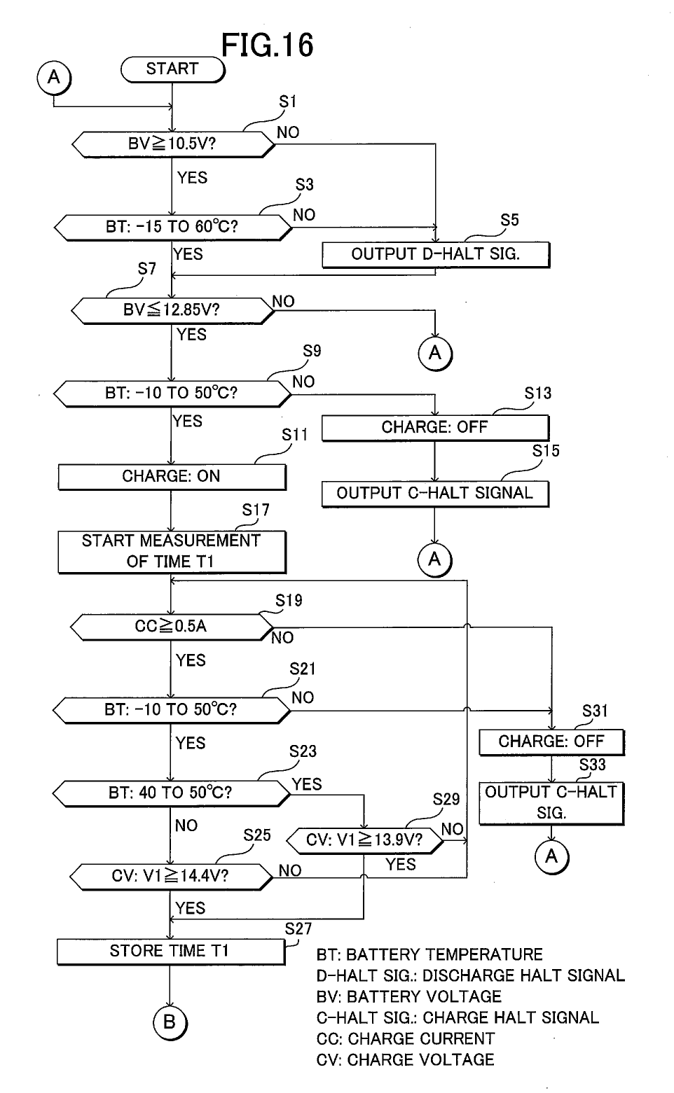

FIG. 16 is a flowchart illustrating charge/discharge control implemented by the microcomputer 310. In the charge/discharge control, the duration of time T2 shown in FIG. 15B is computed. At the time of start of the charge/discharge control, the FET 371 is OFF, since the base current does not flow in the transistor 384 of the charge circuit 370. Hence, the charge path is interrupted and the lead-acid battery 7 is not charged. It should be noted that the microcomputer 310 issues the reset signals independently of the charge/discharge control. The lead-acid battery 7 is charged when the terminals 48 of the inverter device 4 are connected to the commercial power source.

In S1, the microcomputer 310 determines whether or not the voltage of the lead-acid battery 7 detected by the power source voltage detecting circuit 350 is equal to or greater than 10.5 volt. When determination made in Si is affirmative (S1: YES), the microcomputer 310 determines in S3 whether or not the temperature of the lead-acid battery 7 detected by the thermistor 307 (temperature detecting portion 307A) falls in a range between −15 and 60 Centigrade. When the voltage of the lead-acid battery 7 is less than 10.5 volt (S1: NO) or when the temperature of the lead-acid battery 7 is less than −15 Centigrade or above 60 Centigrade (S3: NO), the microcomputer 310 instructs the discharge halt circuit 386 to output a discharge halt signal to thereby halt the discharge of the inverter device 4 and thus halt the discharge from the lead-acid battery 7. Specifically, in response to the discharge halt signal fed from the discharge halt circuit 386, the control portion 401 of the inverter device 4 halts sending signals to one or both of the FETs of the boosting circuit 440 and the inverter circuit 470. This can prevent the lead-acid battery 7 from being over-discharged. Further, because the lead-acid battery 7 is not allowed to be discharged when the temperature of the lead-acid battery 7 is at abnormally low or abnormally high, i.e., out of a predetermined temperature range, abrupt degradation in the property of the lead-acid battery 7 does not occur.

After execution of S5 or when the temperature of the lead-acid battery 7 is equal to or higher than 15 Centigrade or lower than 60 Centigrade (S5: YES), the microcomputer 310 determines in S7 whether or not the voltage of the lead-acid battery 7 detected by the power source voltage detecting circuit 350 is equal to or less than 12.8 volt. When the voltage of the lead-acid battery 7 detected by the power source voltage detecting circuit 350 is larger than 12.5 volt (S7: NO), the routine returns to S1.

The fact that the voltage of the lead-acid battery 7 is larger than 12.8 volt means that the battery voltage is sufficiently high and there is no need to charge the lead-acid battery 7. Accordingly, the charging procedure starting from S11 is not carried out. When an external device is connected to the inverter device 4 or to the sinusoidal-wave adapter 5, the lead-acid battery 7 is allowed to be discharged.

When the voltage of the lead-acid battery 7 as indicated by the power source voltage detecting circuit 350 is equal to or less than 12.85 volt (S7: YES), the microcomputer 310 determines in S9 whether or not the temperature of the lead-acid battery 7 as indicated by the thermistor 307 is equal to or higher than −10 Centigrade and lower than 50 Centigrade. When the determination made in S9 is affirmative (S9: YES), the microcomputer 310 outputs a charge start signal to the base of the transistor 374 of the charging circuit 370 to thereby render the FET 371 ON, allowing the terminals 32A and 31A to be conductive and starting charging the lead-acid battery 7.

On the other hand, when the temperature of the lead-acid battery 7 as detected by the thermistor 307 is lower than −10 Centigrade or equal to or higher than 50 Centigrade, the microcomputer 310 renders the FET 371 of the charging circuit 370 OFF in S13, thereby halting the charging of the lead-acid battery 7. In S15, the microcomputer 310 instructs to output the charge halt signal to the terminal 32F to turn off the switch 489 of the inverter device 4, thereby halting charging the lead-acid battery 7. In other words, charging the lead-acid battery 7 is not carried out under the condition that the temperature of the lead-acid battery 7 is irrelevant to charge. In this manner, the lead-acid battery 7 is treated so as not to be degraded.

In S17, measurement of charging time interval T1 starting from the present time t0 is performed. In S19, the microcomputer 310 determines whether or not the charging current as indicated by the charge current detecting circuit 330 is equal to or greater than 0.5 Ampere. When the determination made in S19 is affirmative (S19: YES), the microcomputer 310 further determines in S21 whether or not the temperature as indicated by the thermistor 307 is equal to or higher than −10 Centigrade and lower than 50 Centigrade (S21: YES), the microcomputer 310 determines in S23 whether or not the battery temperature falls in a range between 40 (inclusive) and 50 (not inclusive) Centigrade. When the determination made in S23 is affirmative (S23: YES), the microcomputer 310 sets the charge voltage V1 to 13.9 volt in S29 (see FIG. 15A) and further determines whether or not the voltage as indicated by the power source voltage detecting circuit 350 is equal to or larger than the voltage V1 (13.9 volt).

When the battery temperature is out of the range between 40 and 50 Centigrade, that is the battery temperature is equal to or higher than −10 Centigrade but lower than 40 Centigrade (S23: NO), the microcomputer 310 sets the charging voltage V1 to 14.4 volt in S25 (see FIG. 15A) and then determines whether or not the voltage as indicated by the power source voltage detecting circuit 350 is equal to or higher than V1 (14.4 volt).

When the voltage of the lead-acid battery 7 as indicated by the power source voltage detecting circuit 350 is equal to or higher than 14.4 volt (V1) (S25: YES), or when the voltage as indicated by the power source voltage detecting circuit 350 is equal to or higher than V1 (13.9 volt) (S29:@ YES), the microcomputer 310 stores the time interval T1 starting from time t0 to the present time t1 in S27. It is to be noted that the present time t1 is the time at which the battery voltage has reached to the voltage V1.

When the voltage as indicated by the power source voltage detecting circuit 350 is lower than 14.4 volt (V1) (S25: NO), or when the voltage as indicated by the power source voltage detecting circuit 350 is lower than 13.9 volt (V1) (S29: NO), the routine returns to S19.

When the charging current as indicated by the charging current detecting circuit 330 is lower than 0.5 Ampere (S19: NO), or the temperature as indicated by the thermistor 307 is out of the range between 10 and 50 Centigrade (S21: NO), a sufficient amount of charge current is not applied or the temperature is not appropriate for charging. Accordingly, in S31, the microcomputer 310 instructs to halt flowing the base current in the base of the transistor 384 of the charging circuit 370 to thereby halt charging the lead-acid battery 7. In S33, the microcomputer 310 outputs the charge halt signal to the terminal 32F to thereby halt the charging function of the inverter device 4.

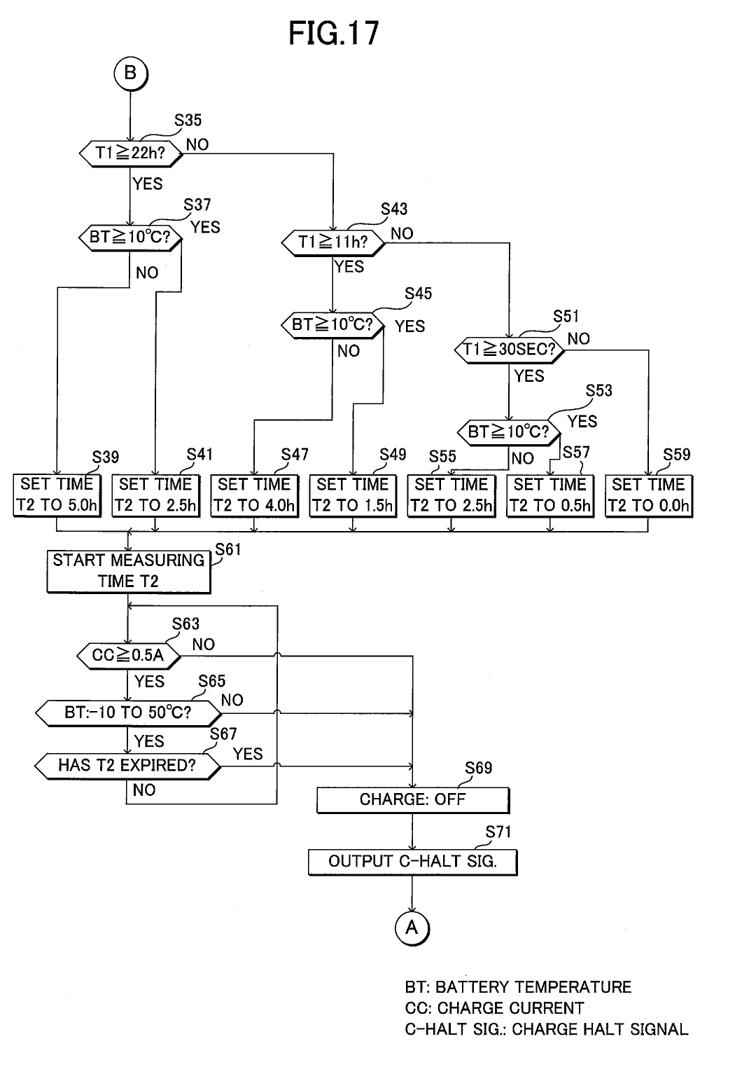

In S35 of the flowchart shown in FIG. 17, the microcomputer 310 determines whether or not the duration of time T1 at which the battery voltage has reached the charge voltage V1 is more than 22 hours. When the determination made in S35 is affirmative (S35: YES), the microcomputer 310 determines in S37 whether or not the temperature indicated by the thermistor 307 is higher than 10 Centigrade. If the determination made in S37 is negative (S37: NO), the microcomputer 310 sets the duration of time T2 indicative of time duration up to completion of charging to 5 hours in S39. When the temperature indicated by the thermistor 307 is equal to or higher than 10 Centigrade (S37: YES), the microcomputer 310 sets the duration of time T2 to 2.5 hours in S41.

When the duration of time T2 is less than 22 hours (S35: YES), the microcomputer 310 determines in S43 whether or not the duration of time T1 is equal to or more than 11 hours. When the determination made in S43 is affirmative (S43: YES), the microcomputer 310 determines in S45 whether or not the temperature indicated by the thermistor 307 is equal to or higher than 10 Centigrade. If the determination made in S45 is negative (S45: NO), the microcomputer 310 sets the duration of time T2 to 4 hours in S47. When the determination made in S45 is affirmative (S45: YES), the microcomputer 310 sets the duration of time T2 to 1.5 hours in S49.

When the duration of time T1 is less than 1 hour (S43: NO), the microcomputer 310 determines in S51 whether or not the duration of time T1 is equal to or longer than 30 seconds. When the determination made in S51 is affirmative (S51: YES), the microcomputer 310 determines in S53 whether or not the temperature indicated by the thermistor 307 is equal to or higher than 10 Centigrade. If the determination made in S53 is negative (S53: NO), the microcomputer 310 sets the duration of time T2 to 2.5 hours in S55. On the other hand, when the temperature indicated by the thermistor 307 is equal to or higher than 10 Centigrade (S53: YES), the microcomputer 310 sets the duration of time T2 to 0.5 h our in S57.

When the duration of time T1 is less than 30 seconds, the microcomputer 310 sets the duration of time T2 to 0 second in S59. That is, completion of charging is determined In S61, the microcomputer 310 computes an expiration period of time from time t1. In S63, the microcomputer 310 determines whether or not the charge current indicated by the charge current detecting circuit 330 is equal to or larger than 0.5 Ampere. When the determination made in S63 is affirmative (S63: YES), the microcomputer 310 further determines in S65 whether or not the temperature indicated by the thermistor 307 is equal to or higher than 10 Centigrade but lower than 50 Centigrade. When the determination made in S65 is affirmative (S65: YES), the microcomputer 310 determines in S67 whether or not the expiration period of time from time t2 exceeds the duration of time T2. If the determination made in S67 is negative (S67: NO), the routine returns to S61. Stated differently, the process executed in S63 and S65 is for determining whether or not the chargeable circumstance is maintained in the duration of time T2 starting from time t1 or until charging is completed.

On the other hand, when the charging current indicated by the charge current detecting circuit 330 is less than 0.5 ampere (S63: NO), when the temperature indicated by the thermistor 307 is less than −10 Centigrade or equal to or higher than 50 Centigrade (S65: NO), and when the expiration period of time starting from time t2 has exceeded the duration of time T2 (S67: YES), the microcomputer 310 renders the FET 371 of the charging circuit 370 OFF to thereby halt charging the lead-acid battery 7. IN S71, the microcomputer 310 instructs to output the charge halt signal to the terminal 32F, thereby disabling the charging function of the inverter device 4.

With the processes described above, the battery adapter 3 is capable of discharging so as to be consistent with the electric characteristic of the lead-acid battery 7. Specifically, in S5, when the voltage of the lead-acid battery 7 falls below 10.5 volt or the temperature of the lead-acid battery 7 is out of the range between −15 Centigrade and 60 Centigrade, discharging the lead-acid battery 7 is not performed. As such, the lead-acid battery 7 is prevented from being over-discharged, as the use circumstance and electric characteristic of the lead-acid battery are taken into consideration when it comes to discharge the lead-acid battery 7.

As described above, the predetermined charge voltage V1 is set based on the temperature of the lead-acid battery 7. The duration of time T2 is determined based on a duration of time T1 at which the lead-acid battery 7 is charged to the predetermined charge voltage V1 as set, and the charge halt time t2 is determined The charging period of time can thus be determined so as to be optimized for the use circumstance and electrical characteristic of the lead-acid battery 7. In other words, the lead-acid battery 7 can be prevented from being under-charged or over-charged. Moreover, charging the lead-acid battery 7 is not performed if the charge current is less than 0.5 Ampere. That is, the lead-acid battery is charged only when a sufficient amount of charge current is supplied. The charge current for the lead-acid battery 7 is about 5 Ampere substantially equal to the charge current for the battery pack 49. During charging the lead-acid battery 7, the charge current may be switched, for example, from 5 Ampere in the duration of time T1 to 1 Ampere in the duration of time T2. By doing so, the charging capacity can be increased as compared with the case in which the lead-acid battery 7 is continuously charged with the same level current, 5 Ampere.

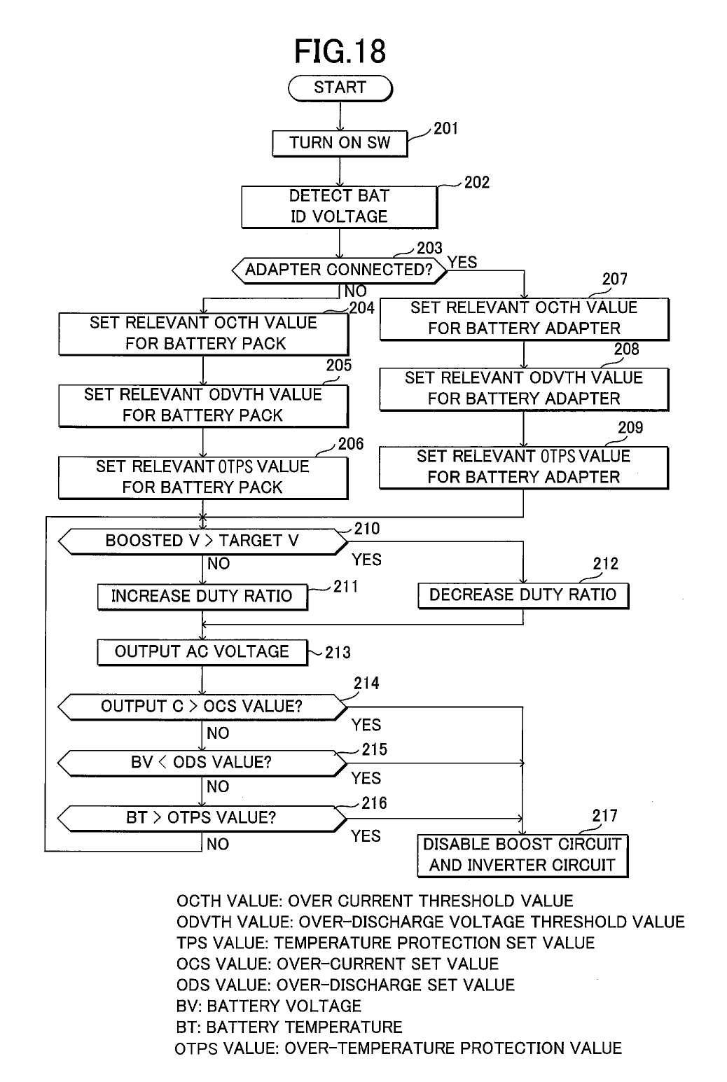

The lead-acid battery does not have associated control circuit for controlling the battery voltage, charge/discharge current, or the like. Direct connection of the lead-acid battery 7 to the inverter device 4 results in over-charge and over-current which may be the causes for degrading the property of the lead-acid battery 7. In accordance with the embodiment of the invention, the lead-acid battery 7 is connected to the inverter device 4 with a specific-purpose adapter 3 interposed therebetween. The adapter 3 houses therein a control circuit for controlling the lead-acid battery 7. The control circuit includes a microcomputer, a voltage monitoring section, a current monitoring section, and an identification section. The control signals received at the inverter device 4 from the adapter 3 can be used to control the lead-acid battery 7 so as not to be placed in an abnormal state causing the battery to be degraded. The inverter device 4 can perform the same operation regardless of the type of the battery connected whichever it may be the lead-acid battery 7 or the battery pack 49. When the adapter 3 is connected, the charge/discharge is controlled in response to the signals fed from the adapter 3. The charging control may be modified depending upon the battery connected. Such a modification will be described while referring to FIG. 18.

Referring to FIG. 18, the output control of the inverter device 4 will be described. In S201, the operator turns on the power switch 425, allowing a voltage to be supplied to the constant voltage circuit 421 from the lead-acid battery 7 and the control section 401 is powered. In S202, the control section 401 receives an identification signal from the terminal 42E. As described, the identification signal is a signal corresponding to the identification resistor 385 of the battery adapter 3 or the identification resistor 49A of the battery pack 49.

In S203, the control section 401 determines whether or not the battery adapter 3 is mounted on the inverter device 4 based on the identification signal. When the battery adapter 3 is not mounted thereon (S203: NO), determination is made so that the battery pack 49 is mounted on the inverter device 4. In S204, the control section 401 sets an over-current threshold value with respect to the battery pack 49. The over-current threshold value is used to prevent the over-current from being discharged from the power source of the inverter device 4, i.e., from the battery pack 49 or battery adapter 3. In S205, the control section 401 sets an over-discharge voltage threshold value with respect to the battery pack 49. In S206, the control section 401 sets an over-temperature protection set value with respect to the battery pack 49. It should be noted that the battery pack 49 houses therein a protection IC which determines over-charge, over-discharge, and over-current within the battery pack 49. Such abnormal status indicating signals are applied to the terminals 42F and 42G of the inverter device 4 so that the control section 401 can control the relevant FETs to halt charging and discharging.

When the battery adapter 3 is mounted on the inverter device 4 (S203: YES), the control section 401 sets the over-current threshold value to a relevant value for the lead-acid battery 7. Because a larger current can flow in the lead-acid battery 7 than in the battery pack 49, the over-current threshold value for the lead-acid battery 7 is set to be a larger value than that for the battery pack 49. In S208, the control section 401 sets the over-discharge voltage threshold value to a relevant value for the lead-acid battery 7. In S207, the control section 401 sets the over-temperature protection set value to a value relevant to the lead-acid battery 7.

In S210, the control section 401 performs measurements of the boosted voltage by voltage-dividing with the resistors 461 and 462, and determines whether or not the boosted voltage is larger than the target voltage. When the boosted voltage is equal to or lower than the target voltage (S210: NO), the control section 401 alters the first PWM signal so that the duty ratio increases. On the other hand, when the boosted voltage is larger than the target voltage (S210: YES), the control section 401 alters the firsts PWM signal so that the duty ratio decreases. In other words, the control section 401 controls the FET 431 so that the boosted voltage developed across the second smoothing capacitor 453 is brought to 141 volt. In S213, the control section 401 outputs the second PWM signal via the PMW signal output section 411. The second PWM signal is an alternating voltage in a rectangular waveform.

In S214, the control section 401 measures the current flowing in the current detection resistor 417 and determines whether or not the measured current is larger than the over-current threshold value. When the measured current is equal to or smaller than the over-current threshold value (S214: NO), the control section 401 detects the voltage of the power source (battery adapter 3 or the battery pack 49) by the voltage-division with the resistors 411 and 412 and determines whether or not the measured power source voltage is smaller than the over-discharge voltage threshold value. When the voltage of the power source (battery adapter 3 or the battery pack 49) is equal to or larger than the over-discharge voltage threshold value (S215: NO), the control section 401 determines in S216 whether or not the temperature of the power source (battery adapter 3 or the battery pack 49) is higher than the over-temperature protection set value. The temperature of the battery adapter 3 is detected by the thermistor 307 and the detected temperature is sent through the terminals 32F and 42F to the control section 401 by the control section 310. The temperature of the battery pack 49 is detected by the thermistor 49B. When the temperature of the power source (battery adapter 3 or the battery pack 49) is lower than the over-temperature protection set value, the routine returns to S210.

In the cases when the measured current value is larger than the over-current threshold value (S214: YES), when the voltage of the power source (battery adapter 3 or the battery pack 49) is smaller than the over-discharge voltage threshold value (S215: YES), and when the temperature of the power source (battery adapter 3 or the battery pack 49) is higher than the over-temperature protection set value (S216: YES), at least one of the boosting circuit 410 and the inverter circuit 470 is disabled to thereby halt outputting the voltage. As such threshold values are set, output of the over-current, occurrence of the over-discharge and abnormal temperature rise of the power source (battery adapter 3 or the battery pack 49) can be prevented depending upon the property of the power source. In lieu of halting the voltage output, the control section 401 may control at least one of the boosting circuit 410 and the inverter circuit 470 so that the voltage output is lowered.

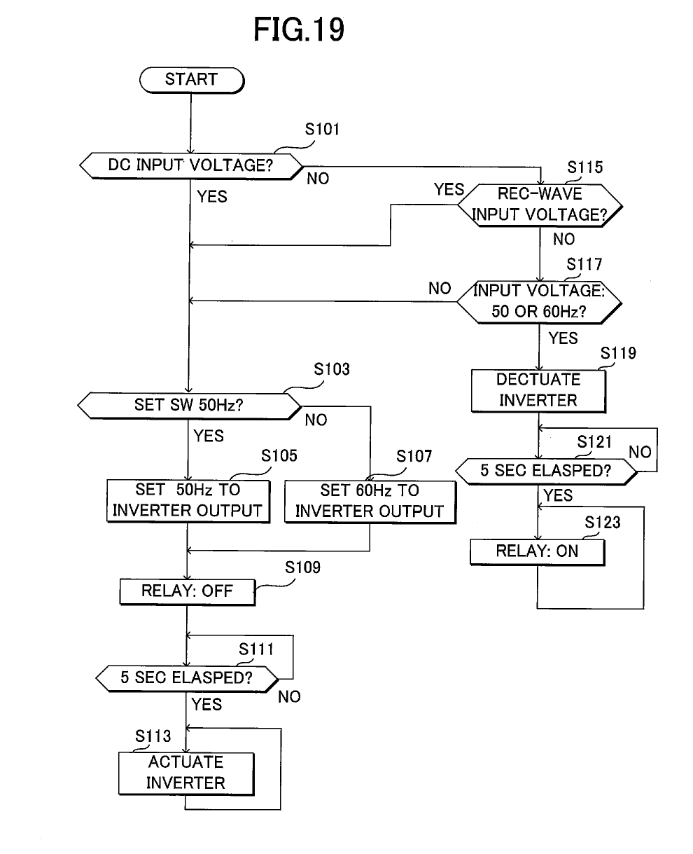

Referring next to the flowchart shown in FIG. 19, the output control of the sinusoidal-wave adapter 5 will be described. In S101, the microcomputer 503 determines whether the input voltage is DC or AC. When the DC voltage is input (S101: NO), the microcomputer 503 determines in S103 whether or not the input voltage is in a rectangular waveform. As shown in FIG. 12C, the rectangular waveform AC voltage has a duration of time T0 at which 0 (zero) voltage lasts. On the other hand, as shown in FIG. 12G, the sinusoidal-waveform AC voltage is only momentarily brought to zero voltage much shorter than the duration of time T0. Here, a reference duration of time Ts is set which is shorter than the duration of time T0 but longer than zero. The reference duration of time Ts is sufficiently longer than the momentous time at which the sinusoidal-waveform AC voltage is zeroed. The microcomputer 503 determines that the input voltage is in the rectangular waveform AC voltage if the duration of time at which the input voltage is zeroed is longer than the reference duration of time Ts (S115: YES) and the routine shifts to S103. On the other hand, the microcomputer 503 determines that the input voltage is in the sinusoidal waveform AC voltage if the duration of time at which the input voltage is zeroed is shorter than the reference duration of time Ts (S115: NO). In S117, the microcomputer 503 determines whether the frequency of the input voltage is 50 Hz or 60 Hz. When the frequency of the input voltage is neither 50 Hz nor 60 Hz (S117: NO), the routine shifts to S103. When the frequency of the input voltage is either 50 Hz or 60 Hz, the microcomputer 503 disables the inverter circuit 508 in S119. In S121, the microcomputer 503 waits for 5 seconds from the time when the inverter circuit 508 is disabled. After expiration of 5 seconds from the time when the inverter circuit 508 is disabled, the AC output is completely interrupted. In S123, the relay circuit 590 (switches 691 and 592) is turned on to allow the input voltage to be output as it is without conversion. 50 Hz or 60 Hz sinusoidal waveform AC voltage is available as it is in general electronic equipment.

On the other hand, in S103, the microcomputer 503 determines whether or not the frequency changeover circuit 520 is set to 50 Hz. If the determination made in S103 is affirmative (S103: YES), the microcomputer 503 sets the output of the inverter circuit 508 to 50 Hz in S105. If the frequency changeover circuit 520 has been set to 60 Hz (S103: NO), the microcomputer 503 sets the output of the inverter circuit 508 to 60 Hz in S105.

In S109, the microcomputer 503 turns off the relay circuit 590 (switches 591 and 592) to prevent the input voltage from being output as it is. In S111, the microcomputer 503 waits for 5 seconds so that the AC output is completely interrupted. In S113, the microcomputer 503 operates the inverter circuit 508 to convert the input voltage to the sinusoidal waveform AC voltage and output the converted voltage.

With the configuration described above, when the sinusoidal waveform AC voltage is input to the sinusoidal-wave adapter 5, the input voltage is not subject to conversion but output as it is. This eliminates power conversion loss which may otherwise occur when the AC waveform conversion is carried out.

While the embodiment of the invention has been described in detail, it would be apparent for those skilled in the art that a variety of changes and modifications may be made without departing from the scope of the invention. For example, while in the above-described embodiment, the sinusoidal-wave adapter 5 is connected to the inverter device 4, it may be connected to a commercial 50 Hz or 60 Hz AC power supply from which sinusoidal-wave voltage is available. Further, the inverter device 4 may be configured to be capable of outputting the sinusoidal waveform voltage and such inverter device may be connected to the sinusoidal-wave adapter 5.

What is claimed is:

1. A battery adapter comprising:
a power source device to which one of a first rechargeable battery and a second rechargeable battery is selectively connectable, the first rechargeable battery having a first outer shape and a first electric characteristic, the second rechargeable battery having a second outer shape different from the first outer shape.

2. The battery adapter according to claim 1, further comprising a control section configured to control charging of the second rechargeable battery, wherein the second rechargeable battery has a second electric characteristic different from the first electric characteristic.

3. The battery adapter according to claim 2, wherein the second rechargeable battery is a lead-acid battery.

4. The battery adapter according to claim 2, further comprising:
a voltage detecting section configured to detect a voltage across the second rechargeable battery;
a temperature detecting section configured to detect a temperature of the second rechargeable battery; and
a current detecting section configured to detect a charge current applied to the second rechargeable battery,
wherein the control section controls the charging of the second rechargeable battery based on the voltage detected by the voltage detecting section, the temperature detected by the temperature detecting section, and the charge current detected by the current detecting section.

5. The battery adapter according to claim 4, wherein the control section is configured to prohibit a voltage output from the second rechargeable battery from being applied to the power source device if at least one of two conditions is met wherein one condition is that the voltage detected by the voltage detecting section is lower than a predetermined value, and another condition is that the temperature detected by the temperature detecting section is out of a predetermined temperature range.

6. The battery adapter according to claim 4, wherein the control section is configured to measure a duration of time up to a time when the voltage detecting section detects the predetermined voltage during charging of the second rechargeable battery and to set a charge end time based on the duration of time thus measured.

7. The battery adapter according to claim 6, wherein the predetermined voltage detected by the voltage detecting section varies depending upon the temperature detected by the temperature detecting section.

8. The battery adapter according to claim 1, further comprising an interrupting section that is configured to interrupt supply of power to the power source device when the power source device is not operating.

9. The battery adapter according to claim 1, wherein the power source device includes a charging section configured to charge the first rechargeable battery, and measure a charging period of time, the battery adapter further comprising an initialization signal transmitting section configured to initialize the charging period of time being measured.

10. The battery adapter according to claim 9, wherein the charging section is further configured to automatically stop charging the first rechargeable battery after expiration of a predetermined period of time, and the initialization signal transmitting section is further configured to transmit an initialization signal to the charging section wherein the charging section initializes the charging period of time being measured in response to the initialization signal.

11. The battery adapter according to claim 9, wherein the power source device includes a waveform conversion section configured to convert a first voltage in a form of a first voltage waveform from the first rechargeable battery or the second rechargeable battery to a second voltage in a form of a second voltage waveform, wherein the first waveform is a DC voltage waveform and the second waveform is a rectangular AC waveform.

12. A power source device comprising:
the battery adapter according to claim 1;
the second rechargeable battery according to claim 1; and
a container accommodating the battery adapter, and the second rechargeable battery, the container having a handle and a wheel.

13. The power source device according to claim 12, further comprising:
a waveform conversion section configured to convert a first voltage in a form of a first voltage waveform from the first rechargeable battery or the second rechargeable battery to a second voltage in a form of a second voltage waveform; and
a sinusoidal-wave adapter connected to the waveform conversion device and configured to convert an input voltage to a sinusoidal-waveform AC voltage.

14. A sinusoidal-wave supplying system comprising:
the battery adapter according to claim 1;
a waveform conversion section configured to convert a first voltage in a form of a first voltage waveform from the first rechargeable battery or the second rechargeable battery to a second voltage in a form of a second voltage waveform;
a sinusoidal-wave adapter connected to the waveform conversion device and configured to convert an input voltage to a sinusoidal-waveform AC voltage, the sinusoidal-wave adapter being further configured to output the input voltage as it is when the input voltage is a sinusoidal-waveform AC voltage.

15. The sinusoidal-wave supplying system according to claim 14, wherein the sinusoidal-wave adapter includes a determining section configured to determine that an AC input voltage applied to the sinusoidal-wave adapter is a sinusoidal-waveform AC voltage if the duration of time at which the zero voltage state lasts is shorter than a predetermined duration of time.

16. A voltage supplying system comprising:
the power source device according to claim 1; and
the battery adapter according to claim 1,
wherein the first rechargeable battery has a first portion to be identified, the battery adapter has a second portion to be identified different from the first portion to be identified, and
wherein the power source device determines which of the first rechargeable battery and the battery adapter is connected to the power source device through identification of the first portion and the second portion.

17. The voltage supplying system according to claim 16, wherein the power source device includes:
an output current detecting section configured to detect a current output from the power source devcie; and
an output protection section configured to lower the voltage outputted from the power source device or halt outputting the voltage therefrom when the current detected by the output current detecting section is larger than an over-current threshold value,
wherein the over-current threshold value varies depending upon the first rechargeable battery or the battery adapter connected to the waveform conversion device.

18. The voltage supplying system according to claim 16, wherein the power source device includes:
an input voltage detecting section configured to detect a voltage inputted from the first rechargeable battery or the battery adapter; and
a voltage protection section configured to lower the voltage outputted from the power source device or halt outputting the voltage therefrom when the voltage detected by the input voltage detecting section is smaller than an over-current threshold value,
wherein the over-current threshold value varies depending upon the first rechargeable battery or the battery adapter connected to the waveform conversion device.

19. The voltage supplying system according to claim 16, wherein the power source device includes:
a temperature detecting section configured to detect a temperature of the first rechargeable battery or the battery adapter; and
a voltage protection section configured to lower the voltage outputted from the power source device or halt outputting the voltage therefrom when the temperature detected by the temperature detecting section is lower than a protection temperature set value,
wherein the protection temperature set value varies depending upon the first rechargeable battery or the battery adapter connected to the power source device.

20. A battery adapter comprising:
a power source device having an input side to which a first rechargeable battery and a second rechargeable battery different in size are selectively connectable, and an output side; and
a cigarette socket terminal provided in the output side of the waveform conversion section.

21. The battery adapter according to claim 20, wherein a voltage outputted from the second rechargeable battery is derived from the cigarette socket without being subjected to waveform conversion.

22. The battery adapter according to claim 20, further comprising:
a voltage detecting section configured to detect a voltage of a rechargeable battery connected to the waveform conversion section; and
an output halting section configured to halt outputting a DC voltage from the cigarette socket when the voltage of the second rechargeable battery detected by the voltage detecting section is smaller than a predetermined voltage value.

23. The battery adapter according to claim 20, wherein the first rechargeable battery has a connecting portion to be connected to the power source section, the battery adapter having a connecting portion same in shape as the connecting portion of the first rechargeable battery.

24. The battery adapter according to claim 23, wherein the cigarette socket terminal is provided in a surface continuous with the connecting portion of the battery adapter.

25. The battery adapter according to claim 24, wherein the connecting portion of the battery adapter has an output terminal connected to the power source section, a DC voltage outputted from the second rechargeable battery is derived from the cigarette socket terminal, and the output terminal is configured to output a voltage to the power source device simultaneously with outputting the DC voltage of the second rechargeable battery.

26. A power source device comprising:
the waveform conversion section configured to perform conversion of a voltage supplied from a first rechargeable battery or a second rechargeable battery, and
the battery adapter according to claim 20.

27. The power source device according to claim 26, wherein the waveform conversion section includes a voltage conversion part configured to convert a DC voltage from the first rechargeable battery or the second rechargeable battery to an AC voltage, and an output part configured to output the AC voltage converted in the voltage conversion part, and wherein the cigarette socket terminal and the output terminal are configured to provide outputs simultaneously.
